(19) United States
(12) Patent Application Publication
(10) Pub. No.: US 2019/0236617 A1
(43) Pub. Date: Aug. 1, 2019

(54) SYSTEMS AND METHODS FOR DATA NORMALIZATION AND SELECTIVE DATA SHARING

(71) Applicant: PartnerTap, Inc., Black Diamond, WA (US)

(72) Inventors: Cassandra Gholston, Black Diamond, WA (US); Jared Gholston, Black Diamond, WA (US); Vara Allamaraju, Redmond, WA (US)

(21) Appl. No.: 15/885,503

(22) Filed: Jan. 31, 2018

(51) Int. Cl. G06Q 30/02; G06Q 30/00

(52) U.S. Cl. CPC G06Q 30/0201; G06Q 30/016

(57) ABSTRACT

Systems and methods are described herein for data normalization and selective data sharing in a partner sharing platform. In one aspect, a method for matching users and sharing selected information may include obtaining first territory information associated with a first user and second territory information associated with a second user, where the territory information includes a plurality of entities each representing a customer or potential customer of the user. The first and second territory information may be normalized to a standard information format, for example according to different rules defined for different fields of the information. The normalized first and second territory information may then be compared to determine common entities. If the two users have at least one common entity, they may be automatically matched, enabling connecting the first user and the second user to selectively share at least part of the first and second territory information.

### COPYRIGHT NOTICE

This disclosure is protected under United States and/or International Copyright Laws. © 2018 PartnerTap. A portion of the disclosure of this patent document contains material which is subject to copyright protection. The copyright owner has no objection to the facsimile reproduction by anyone of the patent document or the patent disclosure, as it appears in the Patent and/or Trademark Office patent file or records, but otherwise reserves all copyright rights whatsoever.

### FIELD OF DISCLOSURE

The current disclosure is directed to data normalization and communication of data according to a tiered access scheme. More specifically, the current disclosure is directed to techniques for linking users according to common geographic attributes and controlling access shared by the users via tiered access scheme.

### BACKGROUND

The field of customer relationship management (CRM) is growing at an increasing rate. Various systems and software, such as Salesforce, have been developed, and are currently evolving, to provide technology for better managing a company's interactions with customers and potential customers. Salesforce, and other similar CRM systems, provide tools to manage contact information and revenue channels to increase sales and productivity of sales associates. While these systems provide useful information when it is needed most, they generally fail to provide techniques for building sales relationships with other companies that provide other products and services, for example, that may not be in direct competition with a certain company using a CRM system. Current systems also fail to provide for an effective platform to share information between sales partners. Accordingly, improvements can be made to current CRM technologies.

### SUMMARY

Systems and techniques are described herein for a partner sharing platform that determines partners (e.g., sales partners) with overlapping territories (e.g., customers) using data normalization. In some aspects, once two partners are determined to have at least one overlapping or matching customer/partial overlapping territory, a connection request or notification may be generated (e.g., automatically) to enable the partners to connect via a partner sharing platform or application. The platform may provide for selection options that enable each partner to control what information is shared with a matched partner. In some aspects, the platform or application may be equipped with different synchronization options to enable directly interfacing with existing CRM systems to obtain up-to-date partner and customer data for determining overlapping territory and sharing various information.

### BRIEF DESCRIPTION OF THE DRAWINGS

FIG. 1 illustrates an example networked system for facilitating the described partner sharing platform.

FIG. 2 illustrates another example of a networked system for facilitating the described partner sharing platform.

FIG. 3 illustrates an example flow diagram of a process for synchronizing data from a CRM with the described partner sharing platform and performing account matching.

FIG. 4 illustrates an example flow diagram of a process for normalizing data, which may be performed by the described partner sharing platform.

FIGS. 5-17 illustrates example views of a graphical user interface provided as part of the described partner sharing platform.

FIGS. 18-20 illustrate example diagrams of account matching parameters, for example, that many be provide by the partner sharing platform.

### DETAILED DESCRIPTION OF THE PREFERRED EMBODIMENT

Systems and techniques for data normalization and tiered access to sharing content are described herein. In one aspect, systems and techniques are described herein for a partner sharing platform that determines partners (e.g., sales partners) with overlapping territories (e.g., customers) using data normalization. Different companies and users (e.g., sales representatives) may use various attributers, parameters, characteristic, etc., to identify customers or potential customers, for example, in custom in-house systems and/or utilizing a Customer Relationship Management (CRM) system. These attributes may be entered and stored in different ways, using different conventions, with different spellings, etc. As a result, a comparison of the same customer between two different users may not result in a match. In order to enable accurate comparison of customers or potential customers across different companies and users, the customer information may be normalized to a standard format or convention, to enable more accurate matching. With more accurate matching between different users, companies, etc., of customers and potential customers, partnership opportunities may be more efficiently and readily determined, to yield efficiency gains in connecting potential sales partners.

In some aspects, once two partners are determined to have at least one overlapping customer/partial overlapping territory, one or more connection requests may be generated (e.g., automatically) to enable the partners to connect via a partner sharing platform or application. The platform may provide for selection options that enable each partner to share various types of information based on a tiered hierarchical structure. In some aspects, the platform or application may be equipped with different synchronization options to enable directly interfacing with existing CRM systems to obtain partner and customer data for determining overlapping territory and sharing various information.

As described and illustrated herein, dashed lines indicated an optional (e.g., not required) operation of a process or component of a system. Like reference numbers refer to similar components or operations. When letters are used at the end of the reference numbers, the letters indicate different instances of a similar component or operation.

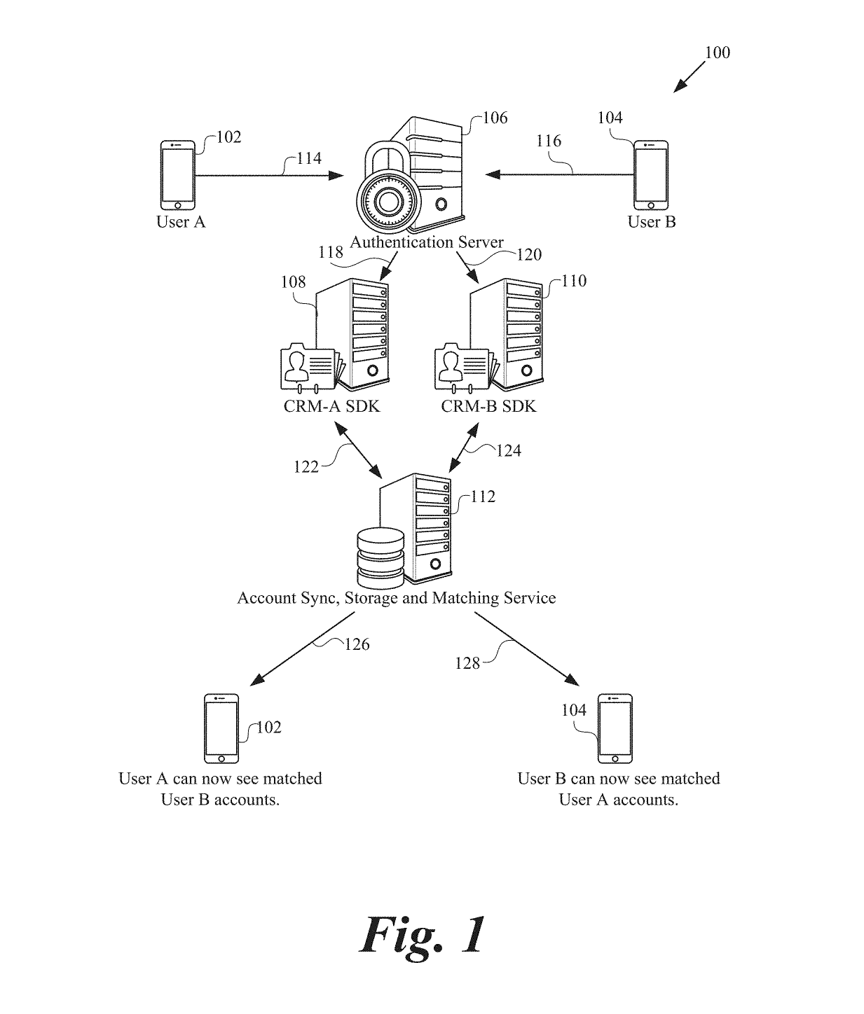

FIG. 1 illustrates an example networked system 100 for facilitating the described partner sharing platform. In some examples, any number of users, via user devices 102, 104 may interface with the platform through an authentication server 106. The user devices 102, 104 may include any of a variety of computing devices, such as smart phones, tablets, laptops, desktop computers, etc. In some aspects, each user may be associated or affiliated with a different company or organization, such as two companies that may provide complimentary services or products. In other aspects, each user may be associated with a different geographical area of the same company, or the same company, such as in the case of a large company where two users may not readily interact. The users may wish to collaborate and share opportunities or leads, such as to form or take advantage of an existing, co-selling partnership. Without the described system or platform, each user would have to manually match their account lists to see where there are possibilities to collaborate (e.g., overlap in customers or potential customers in a territory, for example). Advantageously, using system 100, the users may automatically reconcile their accounts to see where they can collaborate.

In some aspects, each user device 102, 104 may provide credentials (e.g., username, password, etc.) to authenticate an identity with the authentication server 106 of system 100, at operations 114, 116. The credentials may be associated with a sharing platform or application. The authentication server 106 may interface with (e.g., establish an authenticated connection with) one or more Customer Relationship Management (CRM) systems 108, 110 of the respective users, such as Salesforce, Microsoft Dynamics, Hub Spot, etc., through specific SDKs at operations 118, 120. Various services, such as account synchronization, storage, and matching services may be provided by sharing system or application 112, via one or more servers, cloud computing instances, etc. Services of the sharing application 112 may obtain information about each user 102, 104 via the CRMs 108, 110 using CRM specific SDKs, at operations 122, 124. One or more of the services 112 may ensure the data between a given CRM 108, 110 and the sharing application is synchronized. Account, contact, and user profile data may be stored and synced in the sharing platform 112 for processing.

Platform 112 may perform data normalization on the information to standardize relevant information for better comparison. The details of the processes for data normalization will be described in greater detail below. Platform 112 may then compare the information to determine any overlap in customers or territory, or other relevant metrics or information. Platform 112 may make the results of the comparison, and other data, available to devices 102, 104, at operations 126, 128. Details of the specific services provided by platform 112 will be described in greater detail below.

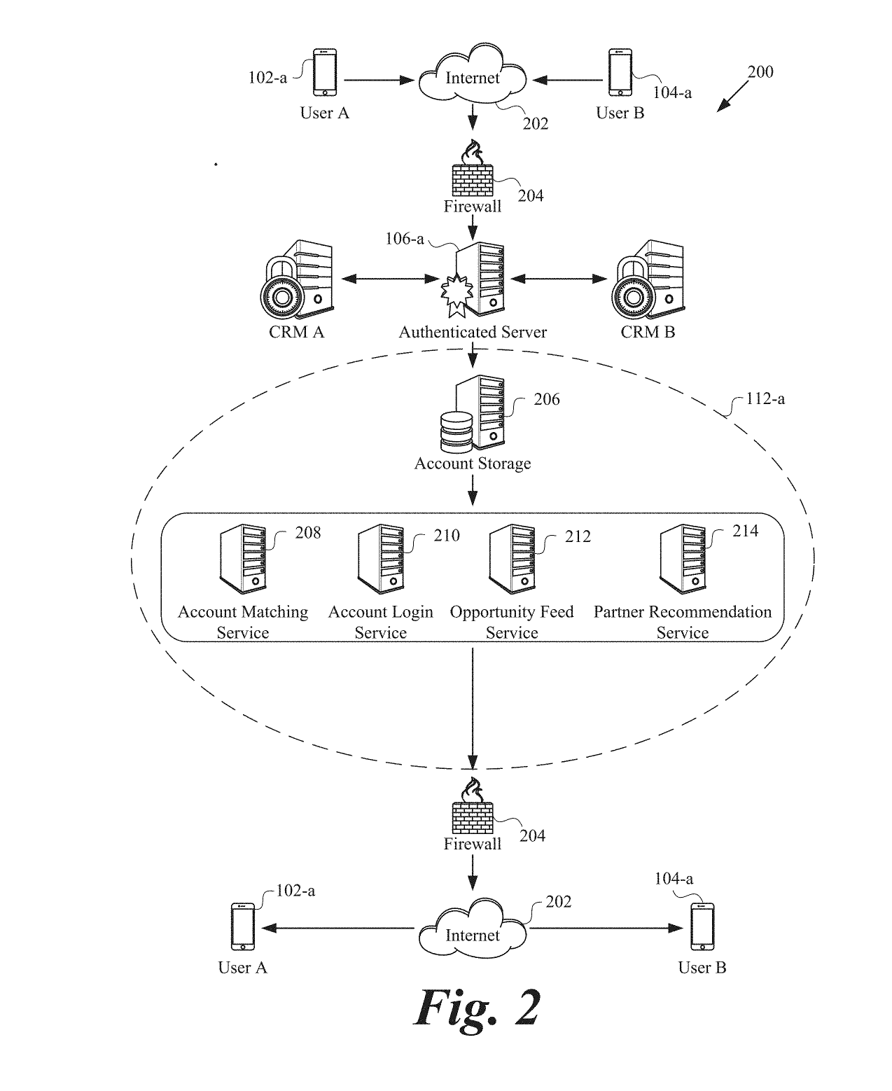

With reference to FIG. 2, another example of a networked system 200 for facilitating the described partner sharing platform 112 will now be described. System 200 may share any of a number of features or aspects with system 100 described above in reference to FIG. 1; as such, these common features will not be described again here. As illustrated, in some aspects, user devices 102, 104 may connect with authentication server 106 via the internet 202 and one or more firewalls 204, as provided by one or more aspects of various data communication networks. In some examples, platform 112 may include account storage 206, such as in the form of one or more databases, tables, data structures, etc., as provided by one or more servers, cloud computing devices or instances, or a combination thereof. In some aspects, some or all of the account information obtained from a CRM 108, 110 for one or more users may be stored in account storage 206, for example, to enable quicker, more efficient access to user information. In other aspects, part of a user's account information may be stored in storage 206, such as often or regularly used information. Platform 112 may additionally include various services, such as an account matching service 208, account logon service 210, opportunity feed service 212, and partner recommendation service 214.

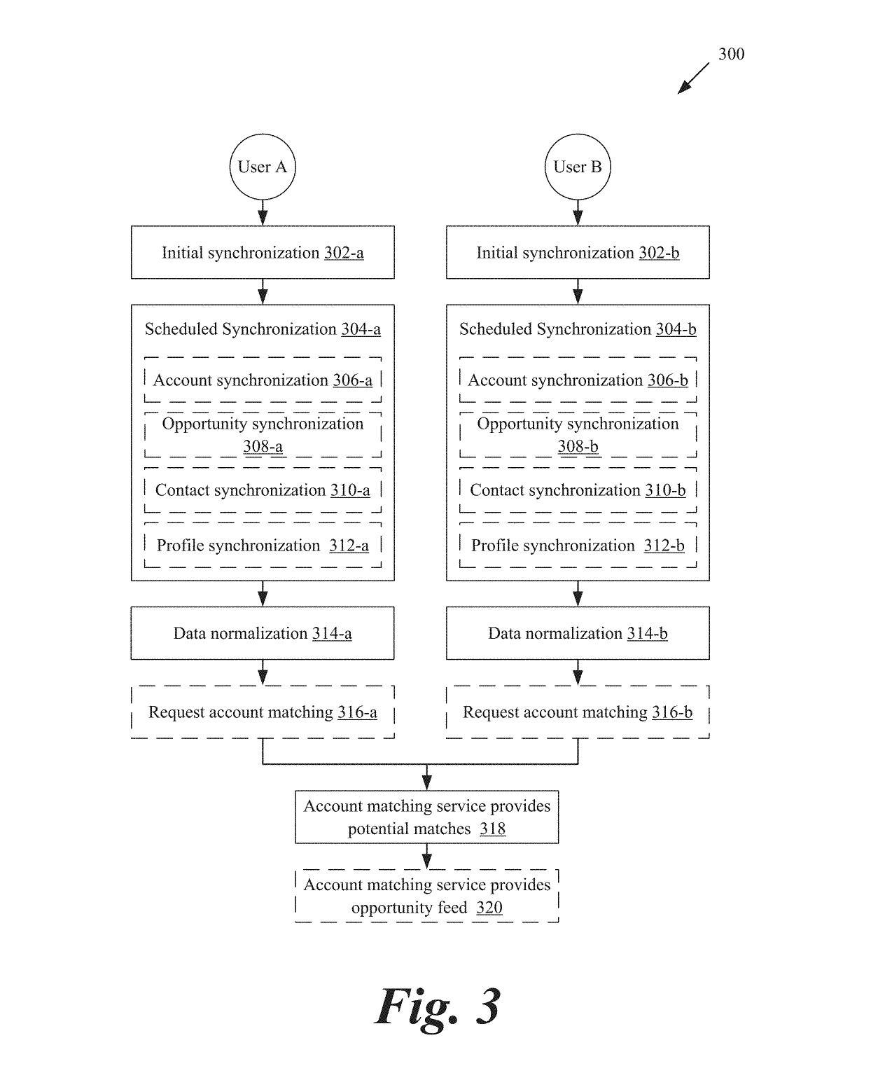

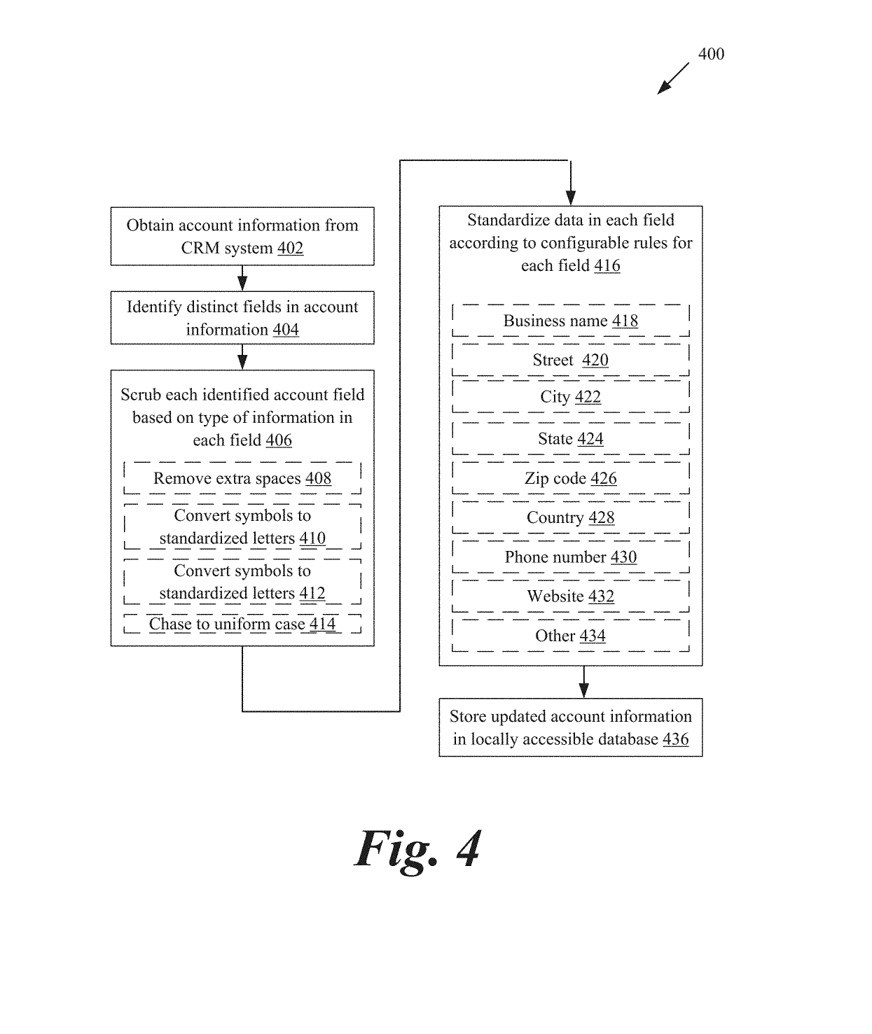

In some aspects, the account matching service 208 may obtain account information, such as account name, address, web site, contact information, etc., from account storage 206 and/or via CRM 108, 110. The account matching service 208 may normalize or modify the account information to enable more accurate comparison of accounts obtained from different CRMs and/or as input in different ways by different users. In some cases, this data normalization process may include de-duping account records using various data points (e.g. account name, address, website, etc.). The account matching service 208 may then store the updated or normalized record in the account storage 206. This may be performed for each user of the platform 112. As a result, account storage 206 may include a unique list of accounts formatted in a standard way to ensure that if UserA and UserB have an account in common, but have mistyped the name, or address, a match may be still be found or determined. Example processes for performing data normalization and account matching will be described in greater detail below in reference to FIGS. 3-4

In some cases, the account login service 210 may authenticate a user and enable access to account information based on credentials provided by the user, according to techniques known in the art.

In some aspects, the opportunity feed service 212 may determine a curated list of opportunities for each user. A relevant list of opportunities gives the user the ability to see where she might collaborate with partners. The list may be populated using data that has been filtered to match an individual's territory and/or partnerships.

In some aspects, the partner recommendation service 214 may recommend new partners to a user based on previous partnering behavior and lack of partners on a particular account, for example. The partner recommendations may be provided periodically, when available or determined on a continuous basis, or according to some other scheme.

In some aspects, platform 112-a may also provide or include a communication or chat service for enabling communication between users/devices 102, 104. In some examples, the chat service may initiate private chat threads with partners on accounts, leads, or relevant information. This allows relevant private conversations to take place between UserA and UserB to encourage collaboration.

In some aspects, platform 112-a may also utilize machine learning to determine if the content of a private chat between UserA and UserB on an account will likely generate a lead or opportunity for either UserA or UserB. A lead or opportunity recommendation may then be determined, for example, by the partner recommendation service 214 and, for example, sent and/or displayed to the user so that she can generate a lead or opportunity with a click of a button or other simplified process.

In some aspects, one or both of statistical and rule based Natural Language Processing (or NLP), or Machine Learning algorithms, may be used to determine the sentiment and topic of a given chat. In some cases, Latent Dirichlet allocation (LDA) in combination with NLP rules may be used for topic identification. Stanford CoreNLP tools may also be utilized to help with name recognition, sentiment, normalization, and natural language parsing. In some aspects, the partner recommendation service 214 may analyze the chats or messages in a chat and using at least one of NLP, machine learning, LDA, or Stanford CoreNLP. If a chat or combination of chats meets one or more thresholds to indicate a potential lead or opportunity, the platform 112-a/partner recommendation service 214 may generate a user interface that provides selections for the user to auto-generate a lead or opportunity in or in conjunction with a CRM. In some aspects, key word or phrase searching may be utilized, alternately to or in addition to, the techniques described above, to determine if a lead or opportunity is likely from a given chat or set of messages. This may include collecting information from a number of chats from different users, tracking which chats result in an opportunity or connection, and correlating key words and phrases with opportunity generation and/or positive post chat activity. This scheme may be used to develop a range of key words and/or phrases that may reasonably identify an opportunity. In some cases, the collected and correlated data may be organized into different groups according to business type, information about the partner or account relationship, or based on other available information.

In another example, a user of device 102 or 104 may be an account manager for a company. The user may desire to track the performance of the co-selling relationship with another company. In this scenario, the platform 112 may utilize a channel analytics service, which may provide a higher level of information and analysis on a combination of account relationships. This service may provide information and analytics that help quantify a partner relationship with another company or group of users, for example, based on lead, relevant information and sales-rep partnering activity. Relevant activity data may be collected during regular use of the platform 112-a, then stored, and processed periodically.

In some aspects, the opportunity feed service 212 may manage the synchronization, de-duplication, and partner mapping of Customer Relationship Management system accounts between partners. Opportunity sharing may provide users of the described system with the ability to stay abreast of the activity of their partners.

FIG. 3 illustrates an example process 300 including a number of operations for synchronizing user accounts and matching potential opportunities between users. In some aspects, process 300 may be performed, at least in part, by various aspects of system 200 described above in reference to FIG. 2, as will be described in greater detail below. Operations 302-316 may be performed for one or more users of the described system, in parallel, at different times, etc. As illustrated, User A may initiate operations 302-a through 316-a, while User B may initiate operations 302-b through 316-b.

Initial Synchronization

Process 300 may begin with operation 302, in which initialize account synchronization may be performed, for example, between the described sharing application and a CRM system associated with a user account, to create an initial user and CRM connection. In some aspects, operation 302 may be performed by account login service 210 of system 200 described above in reference to FIG. 2. In some aspects, operation 302 may include some or all of the following sub-operations:
1. User clicks login with CRM.
2. User is redirected to a CRM hosted login form
3. Upon successful CRM user authentication, CRM redirects to a hosted page with an authentication “code” attached to the url.
4. The authentication “code” is retrieved via javascript and sent to a Login Service
5. The Login Service determines if this is a new user
6. The Login Service has determined the user is new.
7. An OAuth http POST request is created using a specific url, such as: https://na30.salesforce.com/services/oauth2/token, with the authentication “code” as payload.
8. CRM returns a user identity which includes an access token and many CRM user properties. The following information may then be stored to a Profile table: user id, name, email, address, phone number, address. An encrypted CRM refresh token is stored in the THIRD_PARTY_MAPPING table.
9. Now that the user has been authenticated and pertinent information stored, an in memory internal user object is created. The user object contains the identity url, user id, and the CRM access token.
10. The Account Sync Service is initiated.
11. Using the access token, a CRMObject Query Language (SOQL) query, and a http request the users accounts are pulled from the CRM. An example url is as follows: like: https://na30.salesforce.com/services/data/v20.0/query/?q=%query% where “query” is equal to “SELECT Id, Name, Type, BillingStreet, BillingCity, BillingPostalCode, Phone, Fax, AccountNumber, Website, Industry FROM Account WHERE OwnerId=%USERID%”
12. The resulting accounts from the SOQL query are processed to identify if they are a new global account in the system.
13. If the account is not in the system, a new SaleAccount record is created in the SaleAccount DB. The new account is also flagged to be processed in the CRM Account Logo Search system.
14. If the account already exists any new information that can be gleaned is merged into the existing SaleAccount record.
15. A new PersonSaleAccount record is created for each account returned from the SOQL query. Each PersonSaleAccount is mapped to the global SaleAccount record. The PersonSaleAccount→SaleAccount mapping allows the system to process and match users that are partnered on the system.
16. The newly created user is now flagged to be a part of the scheduled systemCRM Account, Contact, Opportunity and Profile Synchronization job.

Scheduled Synchronization

In some aspects, the system may perform scheduled CRM synchronization, which may be configured to run for any length of time, such as 8 or 12 hours (to take advantage of typical times when users are not engaged with the sharing platform), at operation 304. In some aspects, operation 304 may be performed by account matching service 208 of system 200 described above in reference to FIG. 2. CRM synchronization may enable the system to keep or maintain each user's account list, opportunities, contacts, and profile in sync with the user's CRM system. Operations 306 through 312, as described below, include example processes for the synchronization of different types of data.

A. Account Sync

Scheduled synchronization 304, in some aspects, may include account synchronization at operation 306 between a CRM and the described sharing platform. In some aspects, operation 306 may be performed by account matching service 208 of system 200 described above in reference to FIG. 2. In some aspects, operation 304 may include some or all of the following operations:
1. The platform user table is queried for all active users.
2. A CRM refresh authorization token is retrieved for each user from the THIRD_PARTY_MAPPING table.
3. A SOQL query is built to retrieve the following for each account that the each user owns that was modified or created since the last scheduled synchronization: Id, Name, BillingStreet, BillingCity, BillingState, BillingPostalCode, BillingCountry, Phone, Website, Industry
4. An http GET request is created. The url looks like https://na30.salesforce.com/services/data/v20.0/query/?q=%query% where “query” is equal to “SELECT Id, Name, Type, BillingStreet, BillingCity, BillingPostalCode, Phone, Fax, AccountNumber, Website, Industry FROM Account WHERE OwnerId=%USERID% AND LastModifiedDate>%LAST_SYNC_DATE%”. The variable “LAST_SYNC_DATE” represents the most recent successful CRM synchronization for each user.
5. Each modified or new account is examined to see if it is a new account in the system. The SaleAccount table is queried by the account name and billing state. If this return no results the SaleAccount table is then queried by the new account's website address.
6. If the final query of the SaleAccount table returns no results, a new parent SaleAccount record is created. The new SaleAccount is also flagged to be processed in the Account Logo Search system.
7. The user's PersonSaleAccount is linked to the new parent SaleAccount.
8. If the user's PersonSaleAccount already exists in the system, the parent SaleAccount is updated with any new details (e.g. address, phone number, website address). The user's PersonSaleAccount is also updated with any changes.
9. If no errors have occurred then the SYNC_STATISTICS table is updated. The LAST_SYNC_DATE column is updated with the current date and STATUS column updated with the ‘SUCCESS’ flag.

B. Opportunity Sync

Scheduled synchronization 304, in some aspects, may include opportunity synchronization at operation 308 between a CRM and the described sharing platform. In some aspects, operation 308 may be performed by account matching service 208 of system 200 described above in reference to FIG. 2. In some aspects, operation 308 may include some or all of the following operations:
1. The user table is queried for all active users.
2. A CRM refresh authorization token is retrieved for each user from the THIRD_PARTY_MAPPING table.
3. A query is generated to pull all active account ids for each user.
4. A SOQL query is built to retrieve the following data for each opportunity stored in a CRM for each account: name, stage name, last modified date.
5. An http GET request is formed like https://na30.salesforce.com/services/data/v20.0/query/?q=%QUERY% where %QUERY% looks like “SELECT Id, AccountId, Name, StageName, LastModifiedDate FROM Opportunity where AccountId In (%LIST_OF_ACCOUNT_IDS%) and LastModifiedDate>%LAST_SYNC_DATE%” The variable “LAST_SYNC_DATE” represents the most recent successful salesforce synchronization for each user.
6. The CRM returns a list of opportunities for each account for each user. The THIRD_PARTY_MAPPING table is queried to find all existing opportunity mappings.
7. If the opportunity third party mapping exists in the query results then that record is updated with any changes from the opportunity.
8. If the opportunity third party mapping does not exist in the query results then a new record is created in the THIRD_PARTY_MAPPING table as well as in the PERSON_SALE_OPPORTUNITY table.
9. If no errors have occurred then the SYNC_STATISTICS table is updated. The LAST_SYNC_DATE column is updated with the current date and STATUS column updated with the ‘SUCCESS’ flag.

C. Contact Sync

Scheduled synchronization 304, in some aspects, may include contact synchronization at operation 310 between a CRM and the described sharing platform. In some aspects, operation 310 may be performed by account matching service 208 of system 200 described above in reference to FIG. 2. In some aspects, operation 310 may include some or all of the following operations:
1. The user table is queried for all active users.
2. A CRM refresh authorization token is retrieved for each user from the THIRD_PARTY_MAPPING table.
3. A query is generated to pull all active account ids for each user.
4. A SOQL query is built to retrieve the following data for each contact stored in a CRM for each account: AccountId, Title, Email, FirstName, LastName, MobilePhone, Phone.
5. An http GET request is formed like https://na30.salesforce.com/services/data/v20.0/query/?q=%QUERY% where %QUERY% looks like “SELECT AccountId, Title, Email, FirstName, LastName, MobilePhone, Phone FROM Contact where AccountId In (%LIST_OF_ACCOUNT_IDS%) AND LastModifiedDate>%LAST_SYNC_DATE%” The variable “LAST_SYNC_DATE” represents the most recent successful salesforce synchronization for each user.
6. Salesforce returns a list of contacts for each account for each user. The THIRD_PARTY_MAPPING table is queried to find all existing contact mappings.
7. If the contact third party mapping exists in the query results then that record is updated with any changes for the contact.
8. If the contact third party mapping does not exist in the query results then a new record is created in the THIRD_PARTY_MAPPING table as well as in the PERSON_SALE_CONTACT table.
9. If no errors have occurred then the SYNC_STATISTICS table is updated. The LAST_SYNC_DATE column is updated with the current date and STATUS column updated with the ‘SUCCESS’ flag.

D. Profile Sync

Scheduled synchronization 304, in some aspects, may include profile synchronization at operation 312 between a CRM and the described sharing platform. In some aspects, operation 312 may be performed by account matching service 208 of system 200 described above in reference to FIG. 2. In some aspects, operation 308 may include some or all of the following operations:
1. The user table is queried for all active users.
2. A Salesforce refresh authorization token is retrieved for each user from the THIRD_PARTY_MAPPING table.
3. An http GET request is formed like “https://login.salesforce.com/id/%USER_ID%” where USER_ID is the users' CRM user id.
4. The CRM returns a JSON payload containing the following: username, password, user_id, email, first_name, last_name, addr_street, addr_city, addr_state, addr_country, addr_zip, mobile_phone, photos
5. If the profile already exists in the PROFILE table the record is updated with any changes to the payload returned from the CRM,including any changes to their profile photo, which is pushed to an Amazon S3 bucket.
6. If the profile does not exist in the PROFILE table a new record is created linking the user to this new PROFILE table record. The profile user photo is then stored in an Amazon S3 bucket.
7. If no errors have occurred then the SYNC_STATISTICS table is updated. The LAST_SYNC_DATE column is updated with the current date and STATUS column updated with the ‘SUCCESS’ flag.

Process 300 may further include operation 314, in which account data may be normalized. Operation 314 may include converting various identifiers of customers or potential customers to a standardized form to enable more accurate matching between different user accounts. Techniques for performing data normalization will be described in greater detail below, in reference to FIG. 4. It should be appreciated that operation 314 may be performed before, after, or during other operations of process 300, once initial synchronization has been performed at operation 302.

Process 300 may additionally include operation 316, in which a request for account matching may be initiated, for example, by one or more of Users A or B. In some aspect one user may request an account match. In other aspects, the account matching may be performed without a specific request from a user, such as periodically or upon detection of a potential match between users.

Account Mapping Service

In some aspects, process 300 may include operation 318, in which potential matches between different users may be generated and provided to one or more of the involved users. In some aspects, the account mapping service, such as service 208 described above, may use the parent SaleAccount data and individual PersonSaleAccount data to automate account matching for two linked users (partners) in the system. In other cases, account matching may be performed upon manual selection or activation, for example, between two unmatched users or two matched users. In some aspects, operation 318 may be performed by account matching service 208 of system 200 described above in reference to FIG. 2. In some aspects, operation 318 may include some or all of the following operations:
1. Platform user-A and user-B must be registered users of the platform by completing the Initial Synchronization.
2. Using the application user-A searches for user-B.
3. User-A types in user-B's name “John Doe”.
4. A query is executed against the PROFILE table. The query searches by first name, last name, and organization.
5. Results of the PROFILE table search are displayed to the user.
6. User-A taps the “invite partner” button within the result list item “John Doe”.
7. A partner invite is stored in the PARTNER_INVITE table. A sms message is sent to user-B to notify them of the request.
8. User-B receives the partner invite sms and opens the application/platform.
9. User-B taps the “Partner Tab”.
10. User-B has a partner invitation request at the top of his “Partner Page”.
11. User-B taps the “accept partner” button.
12. The client application generates a PUT request with the url pattern “/partners/%user-A id%” with a payload like {“ownerId”: %partnerId%, “personId”: %userId%, “status”: “REQUESTED”}.
13. The platform api validates that the incoming partner request is formatted properly.
14. The service then checks if a partner request already exists between the two users. If there is a request already present a message “You already REQUESTED to partner with this person” is sent back to the client application. If the two users are already accepted partners a message “You and this person are already partners” is sent back to the client application.
15. If the service determines that this is a new partner request, a new row is injected into the PARTNER table. The row contains the OWNER_ID, PERSON_ID, and STATUS of “requested”. The OWNER_ID is the user who is receiving the request and the PERSON_ID is the requester's user id.
16. A push notification is sent to the OWNER_ID.
17. The OWNER_ID user receives the push notification on their device. The user then opens the client application.
18. The OWNER_ID user clicks on the “Partners” tab within the client application.
19. A partner request message is displayed to the user, the user then clicks the “accept partner” button.
20. The client application generates a PUT request with the url pattern “/partners/%user-A id%” with a payload like {“ownerId”: %partnerId%, “personId”: %userId%, “status”: “ACCEPTED”}.
21. The platform api validates that the partner relationship update request is valid.
22. If the request is valid the PARTNER table record is updated with the status “ACCEPTED”.
23. Now that a partnership is established between User-A and User-B, the system can now respond to account mapping requests.
24. User-A clicks on the “Partners” tab.
25. User-B displays as a connected partner on User-A's client application.
26. User-A clicks on the User-B partner link.
27. A platform api request is sent from the client application. The http GET request has the url pattern “/partners/%USER-B_ID%”.
28. The platform api validates that the User-B ID is valid, then queries the database for the User-A/User-B partnership from the PARTNER table.
29. The User-A id and User-B id are used to query the PERSON_SALE_ACCOUNT table for all the accounts they have in common. The query may look like: select CAST(count(o.sale_account_id) AS integer) from person_sale_account o, person_sale_account p where o.sale_account_id=p.sale_account_id and o.person_id=%USER-A_ID% and p.person_id=%USER-B_ID and o.status=‘ACTIVE’ and p.status=‘ACTIVE’.
30. The query results are counted and returned to the client app to be displayed.
31. User-A clicks the ‘Matched Accounts’ button.
32. A platform api request is sent from the client application. The http GET request has the url pattern “/accounts/shared/?personAId=%USER-A_ID%&personBId=%USER-B_ID”
33. The platform api validates that personAId and personBId arguments are not null or formed improperly.
34. A query is then generated to pull all of the matched accounts for User-A and User-B. The query looks like: “select o. * from person_sale_account o, person_sale_account p where o.sale_account_id=p.sale_account_id and o.person_id=%USER-A_ID% and o.status=‘ACTIVE’ and p.status=‘ACTIVE’ and p.person_id=%USER-B_ID%”.
35. The platform api returns a payload of all of the matched accounts between User-A and User-B. The payload looks like:

1. [
2. {
3. “id”:“2c9f985d58c644cb0158c6e817b5006d”,
4. “saleAccountId”:“2c9f985d58c644cb0158c6494bcf001a”,
5. “name”:“Burlington Textiles Corp of America”,
6. “contactPhoneNumber”:“(336) 222-7000”,
7. “street”:“525 S. Lexington Ave”,
8. “city”:“Burlington”,
9. “state”:“NC”,
10. “country”:“USA”,
11. “zipCode”:“27215”,
12. “status”:“ACTIVE”,
13. “logoUploaded”:true
14. }, {...more results}
15. ]

36. The payload is converted to DOM elements and displayed to User-A.
37. The Scheduled Synchronization keeps User-A and User-B account lists up to date. Therefore any user request to see matched accounts will be relevant and up to date.

Opportunity Feed

In some aspects, process 300 may additionally include operation 320, in which an opportunity feed may be generated and provided to one or more users. The Opportunity Feed or “Tap” is a list of sales opportunities that have been opened or closed and that are recent and relevant to a user/account. Opportunities may be kept updated by the Scheduled Synchronization system detailed above. In some aspects, operation 320 may be performed by opportunity feed service 212 of system 200 described above in reference to FIG. 2. In some aspects, operation 320 may include some or all of the following operations:
1. User-A clicks the “Tap” tab in the client application.
2. A http GET request is formed like so “/opportunities/network/?personId=%USER-A_ID%”
3. The platform API receives the GET request and creates a database query against the PERSON_SALE_OPPORTUNITY, PERSON_SALE_ACCOUNT, and PARTNER tables.
4. The query looks like this: select o.* from person_sale_opportunity o where (o.person_id in (select a.owner_id from partner a where a.owner_id in (select p.person_id from partner p where p.owner_id=%USER-A_ID% and p.status=‘ACCEPTED’) and a.person_id=%USER-A_ID% and a.shared_opp=true)) and o.sale_account_id in (select s.sale_account_id from person_sale_account s where s.person_id=%USER-A_ID%)
5. This query returns all of the sales opportunities from users that are partnered with User-A, have SALE_ACCOUNTs in common, and have “Share Opportunities” enabled.
6. The following information is available for each result from the query: account name, user name, status (open/close), and timestamp.
7. The results are sorted by date (newest first).
8. The results are returned to the client application and rendered for User-A.
9. User-A can now request intelligence directly from opportunities that appear in the feed.

Data Normalization

A primary function of the account matching service 208 is to match two or more sale accounts. It is used by the on demand Initial Synchronization/off line Scheduled Synchronization Account Sync workflows. This is an important feature of the described system, as the matching sales accounts between two salespersons enables them to share intel, leads or opportunities, etc. This has been done in two stages, as described below.

The Sale Account data of a given user comes from a user's CRM account. Hence it is not standardized. Each company may enter the details of the accounts (aka Companies) they target entered in a free form, which may hinder account matching or render it not possible. In order to match the accounts, the described system may employ data normalization techniques. In some aspects, some or all of the elements in the sales account may be normalized.

Generally, a Sale Account has Name, Street, City, State, Zip, Country, Phone, Website data fields. Each of these elements may be normalized in different ways by passing different stages. Since all attributes of sales account are generally strings, two strings are considered different unless they match exactly. In order to match the strings, data cleansing techniques can be employed to all attributes and specific normalizing techniques then may be applied based on specific attributes.

FIG. 4 illustrates an example process 400 for normalizing or standardizing account data to enable more accurate account matching. In some aspects, process 400 may be performed by the account matching service 208 of system 200 described above in reference to FIG. 2. In yet some aspects, operation 314, as described above in reference to FIG. 3, may include one or more aspects of process 400, such that some or all of process 400 may be performed in place of operation 314. Process 400 is only given by way of example. Process 400 may add or omit one or more operations and still be within the scope of the subject matter contemplated herein. For example, different rules may be configured for data scrubbing and/or data normalization, rules may be applied to some or all of the described fields, etc. In some cases, additional fields may be processed in a similar way.

Process 400 may begin at operation 402, which includes obtaining account information, for example from a CRM system, such as a CRM system associated with a particular user account. At operation 404, distinct fields of the account information may be identified. This may include detecting strings of characters of certain lengths and/or have certain characteristics (e.g., certain characters, the existence of numbers or other symbols, and so on). Next, the information or string of characters contained in some or all of the identified fields may be scrubbed or cleaned, at operation 406. Operation 406 may include one or more of operations 408-414. For example, extra or trailing/leading spaces may be removed, at operation 408. Additionally or alternatively, at operation 410, symbols, such as ampersands and the like may be converted to letters. For example, “AMD & Associates Inc” may be converted to “AMD and Associates Inc.” This may enable a comparison to of the two entries to identify a match, when without the data scrubbing, a match would not be found. Additionally or alternatively, at operation 412, symbols may be converted to letters/all non-alpha characters may be removed and replaced. For example, “Dazadi, Inc. . . . ,” may converted to “Dazadi Inc,” and “Hitachi Computer Products (america), Inc.” may be converted to “Hitachi Computer Products America Inc.” Additionally or alternatively, at operation 414, the field string may be converted to a uniform case, such that lower, upper, or camel case all may be normalized with UpperCase. For example, “partnerTap,” “Partnertap,” and “PartnerTap” may all be changed to “PARTNERTAP.”

Process 400 may then proceed to operation 416, where the data in each field may be standardized or normalized according to rules for each field. Hence each attribute or field may be normalized in a different way. The specific end value, and format thereof, is not particularly important. Rather, the standardized usage of the same conventions throughout the system may provide the advantage of enabling more accurate data matching. A number of examples are provided and described below. It should be appreciated, however, that various other data fields and end values or normalizations are contemplated herein.

Business Name may be normalized at operation 418, for example including normalizing for the type of business. For example, PartnerTap Inc., PartnerTap Incorporated, ParternTap Corp, and PartnerTap Corporation may all be normalized for Corporated as for the type of business.

Additionally or alternatively, street information may be normalized at operation 420. In some cases, street names may be normalized for the directions and other generic keywords. For example, NE, NORTH EAST, AVE, AVENUE etc., may be normalized. In another example, the “#” character may be replaced with “Suite”: “1 Main Street #500” may be replaced with: “1 Main Street Suite 500.”

Additionally or alternatively, city information may be normalized at operation 422. In some cases, user manual entry may cause some city names to be often misspelled. In some aspects, city names may be normalized for the correct name. Often city names are mismatched, even though they are the same city. For example, “San Francisco” may be normalized to “San Francisco.” In some cases, city name normalization or correction may take into account zip code and/or state name to help identify the intended city name, according to known or most common cities in a zip code, state, etc.

Additionally or alternatively, state information may be normalized at operation 424. In some cases, states names are abbreviated, sometimes they are fully spelled, sometimes they are abbreviated hyphen spelled, etc. Hence often they are mismatched even though they are the same state. State name be normalized to following one format, such as converting any of the following: WA, Washington, WA-Washington, to WA. In some cases, state name may be corrected, for example, based on a comparison of zip code or city name, to match the state with a city or zip code found in that state.

Additionally or alternatively, zip code information may be normalized at operation 426. In some cases, zip codes may be 5 plus 4 digit extensions, but often are 5 digits. Hence often they are mismatched even though they are the same zip code. Zip code may be normalized for 5 digits. For example each of the following: “98-74” and “98074-3456” may be converted to “98074.” In some cases, zip code may be corrected, for example, based on a comparison of state or city name, to match the zip code with a city or state corresponding to a certain zip code.

Additionally or alternatively, country information may be normalized at operation 428. In some cases, country names are fully spelled, represented by two or three characters, or represented in other ways. Hence often they are mismatched even though they are the same name. For example all of the following examples: United States, United States of America, USA, US, US of A, may be normalized to US. In some cases, country name may be corrected based on city, state, and/or zip code information, to match the country with a specific entry in one of these fields, certain characters (e.g., English or other characters), certain conventions (zip codes), and so on.

Additionally or alternatively, phone number information may be normalized at operation 430. In some cases, phone numbers may include +country code, may not include country code, and/or may include parenthesis and hyphens to separate area code with the rest of the numbers. Hence often they are mismatched even though they are the same number. Depending on the application (e.g., in one country primarily or exclusively), phone numbers may be normalized to “XXX-XXX-XXXX.” In other aspects, country code may be included with the +sign, when for example, phone numbers from multiple different countries are anticipated. In some cases, country code may be added or corrected based on country information provided, or vice versa.

Additionally or alternatively, website information may be normalized at operation 432. In some cases, websites come in different forms even though they are of the same website. Hence they are mismatched. Website information can be normalized, for example, including removing or stripping protocol, port number, extension, authority, etc., information. In some examples, this may include “WWW.WEBSITE_NAME.xxx.”

In yet some cases, account information may contain other fields, and those fields may be normalized according to other metrics or standards.

After some or all the fields of an account entry have been normalized at operation 416, the updated record may be stored, for example, in a locally accessibly database, such as account storage 206 of system 200 described above in reference to FIG. 2, at operation 436.

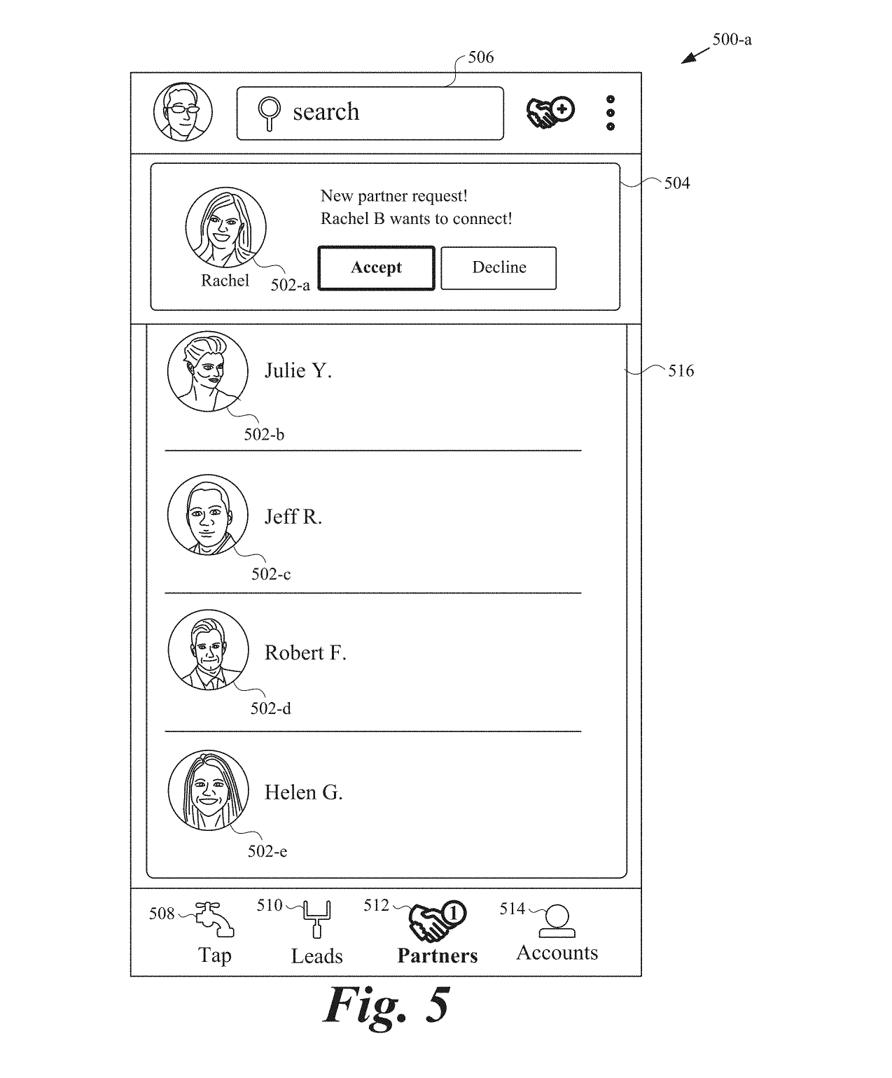

FIG. 5-17 illustrates example views 500-a through 500-1 of a graphical user interface (GUI) provided as part of the described partner sharing platform. In some aspects, GUI 500 may be generated and displayed on a user device 102 or 104, for example, connected to the partner sharing platform application or system 100, 200 described above. In some aspects, some or all of views 500-a through 500-m may be formatted specifically for mobile users or desktop users, or a combination thereof.

In some aspects, GUI 500 may include a search option 506, and various primary selection options: tap 508, leads 510, partners 512, and accounts 514. Upon selection of one of items 508-514, a main portion 516 of display 500 may provide additional information and selection options relating to the selected item of 508-514.

With reference to FIG. 5, view 500-a illustrates selection options 502 corresponding to different partners in area 516, displayed in response to selection of the partners item 512. View or display screen 500-a may include a number of selectable icons 502 representing different partners associated with a user account. View 500-a may include new or pending partners requests, such as request 504. View 500-a may enable addition, deletion, searching, and other functions related to connecting with different partners.

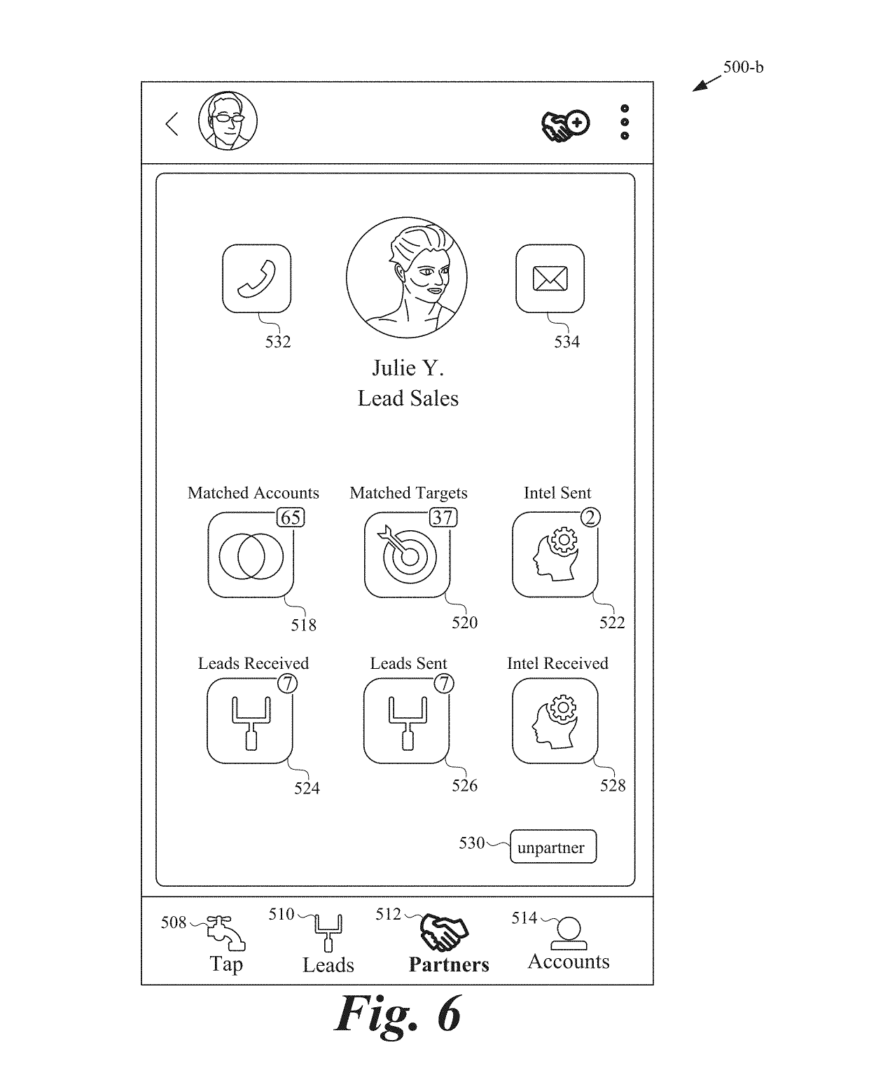

With reference to FIG. 6, view 500-b illustrates a more detailed view of a selected partner, selected, for example, from view 500-a. View 500-b may include selectable icons for contacting the selected partner, such as through phone 532 or email 534. Various information may be organized and displayed, for example, upon selection of one or more items relating to a specific partner, including: matched accounts 518, matched targets 520, intel scan 522, leads received 524, leads sent 526, intel received 528, etc. In some aspects, a partner may also be disassociated with an account via selection of the un-partner item 530. In this way, various details of the relationship with specific partners can be accessed and managed, to facilitate more efficient account sharing.

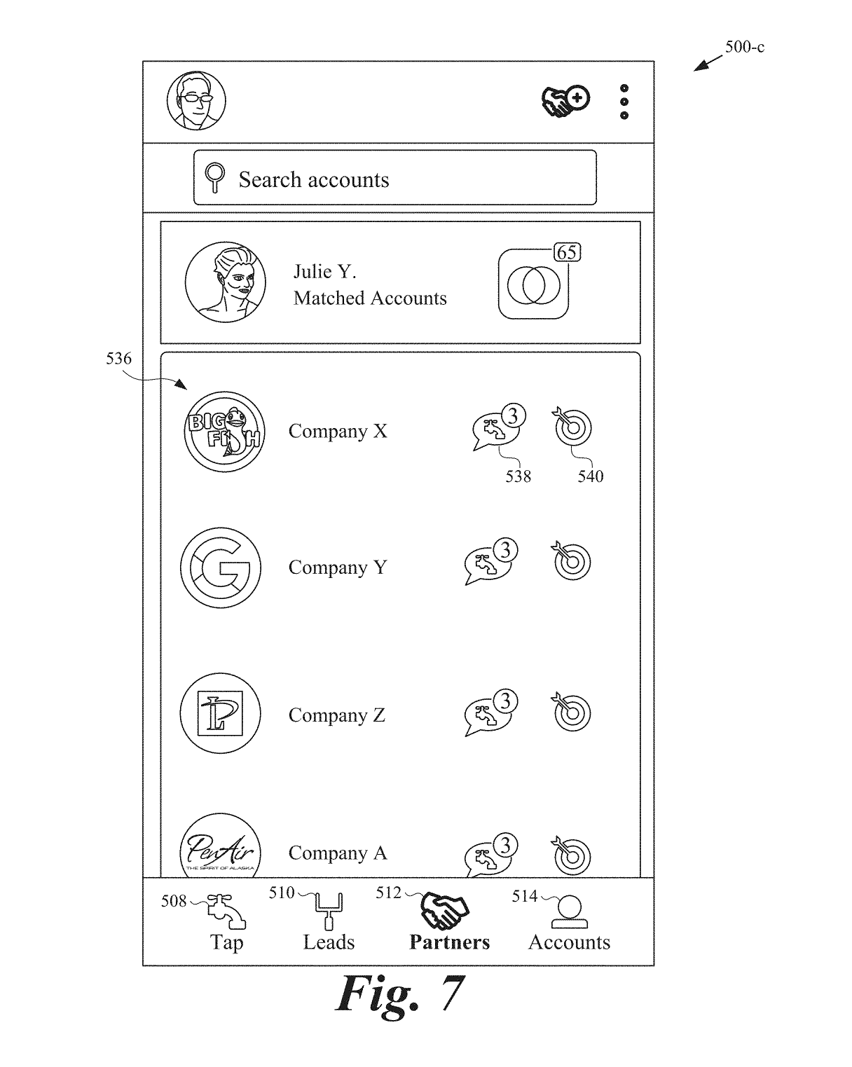

With reference to FIG. 7, view 500-c illustrates more detail and selection items concerning matched accounts, which may be accessed and displayed, for example, upon selection of matched accounts item 518 of view 500-b. View 500-c may include a list of matched accounts 536 with various attributes of each matched account, including tap information 538, which may include prior communications with a user associated with the matched account, and other information 540. In one example, other information 540, upon selection, may access potential leads or opportunities that the specific user has already attempted to develop. This may include, for example, a target that the associated user has previously contacted.

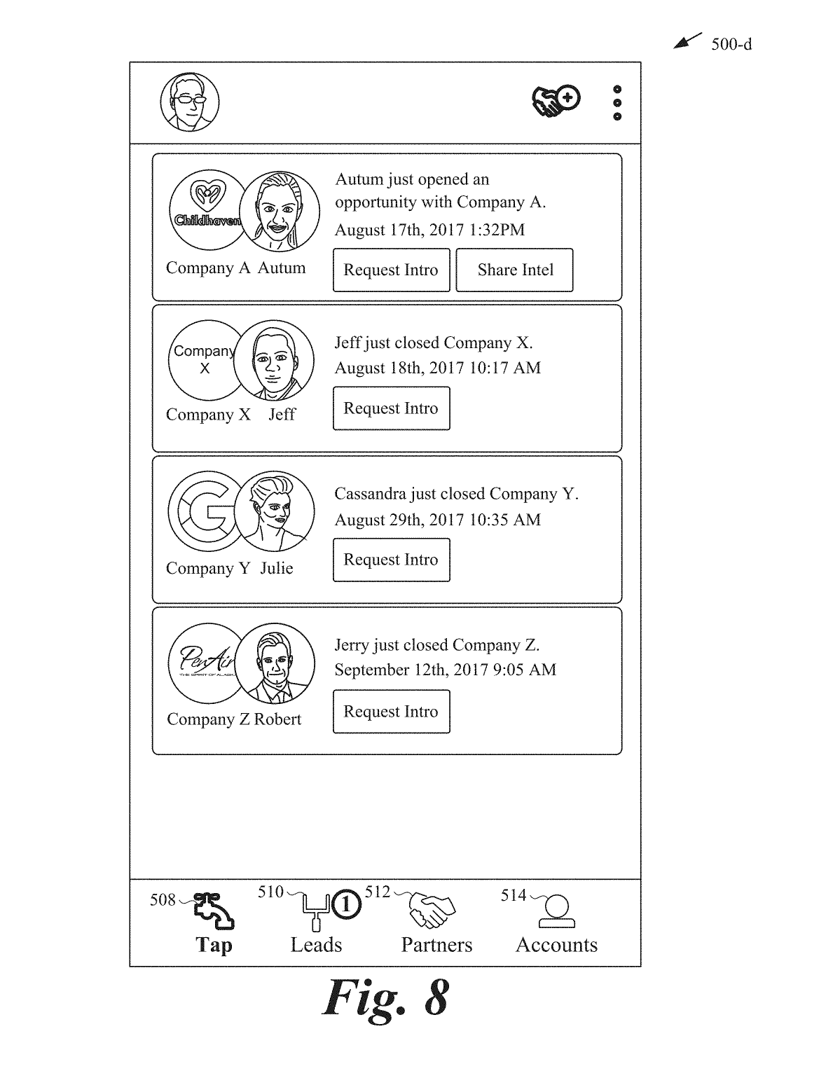

With reference to FIG. 8, view 500-d illustrates tap information, which may be displayed upon selection of tap icon 508, or via tap icon associated with a matched account 538. View 500-d may include various information relating to activities of partners or users linked to a user's tap, such as activity relating to specific opportunities, a company the user is associated with or the user's activity is associated with, a request introduction selection, a share intel selection, or other relevant information.

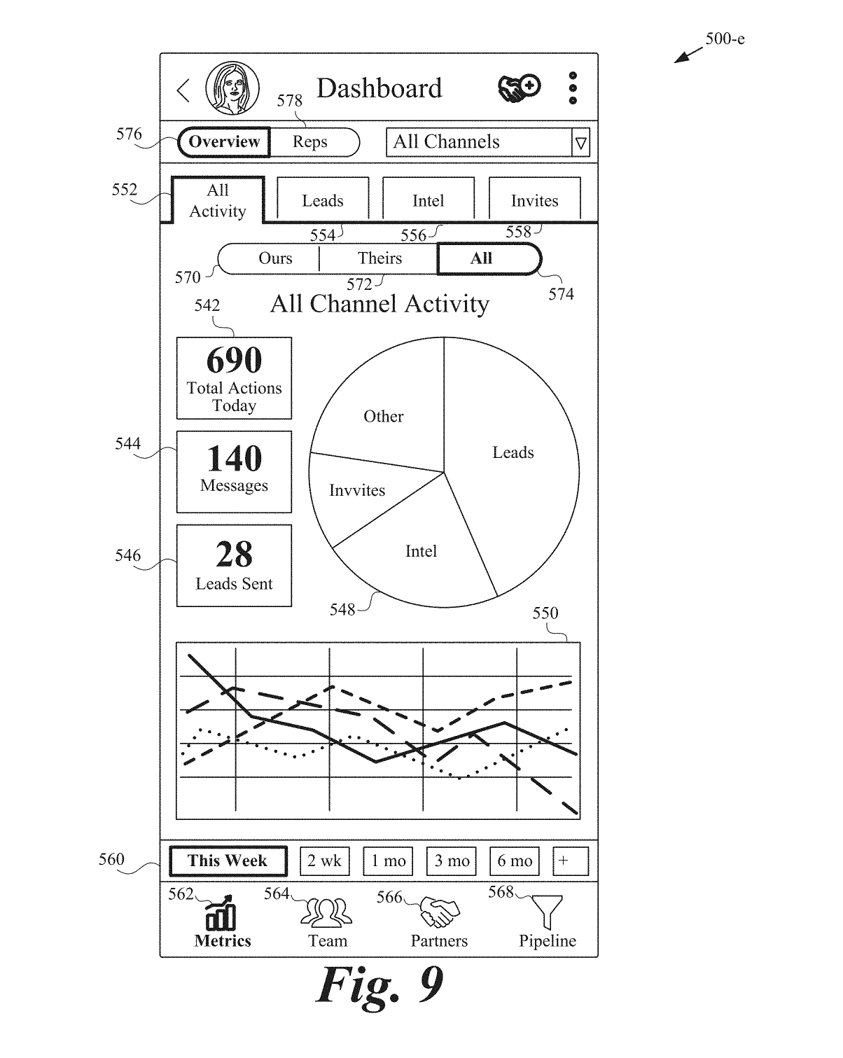

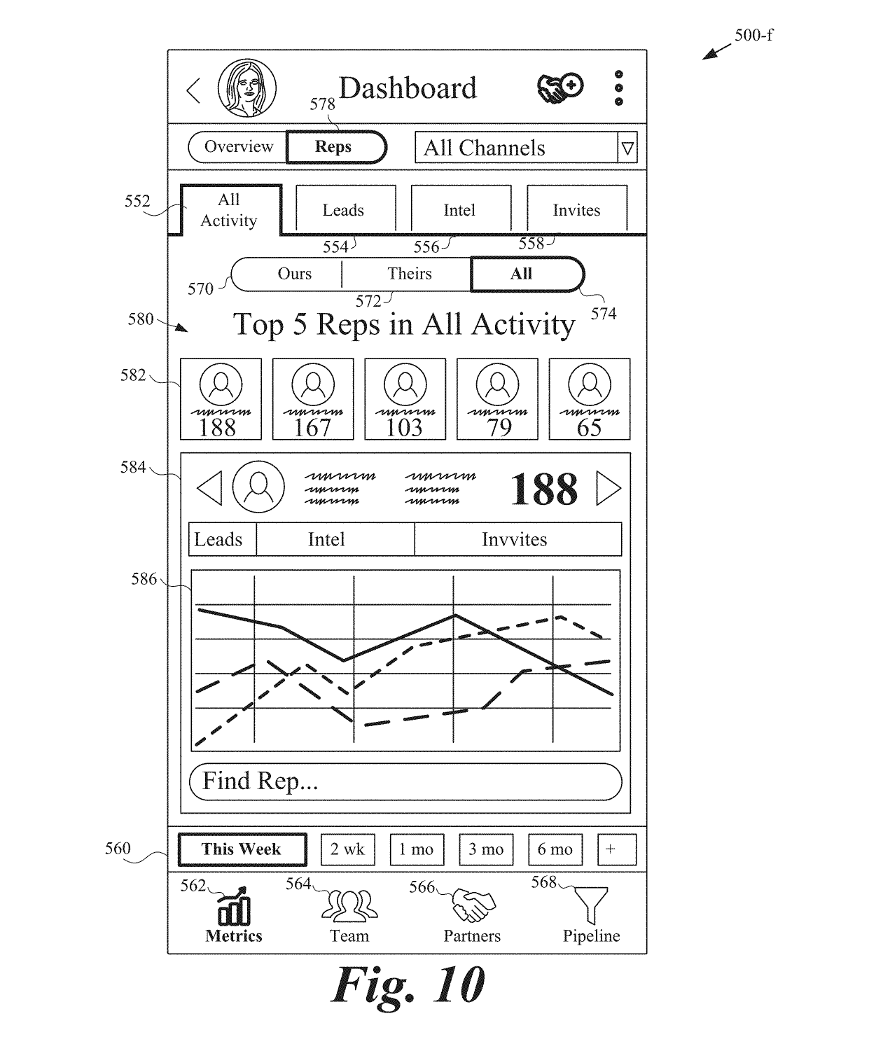

With reference to FIGS. 9 and 10, view 500-e and 500-f illustrate example dashboards relating to channel activity, for example, on the company level. Views 500-e and 500-f may enable a high level of coordination and access to higher level information, to enable more productive engagements between companies. This may include metrics information 562, team information 564, partner information 566, and pipeline information 568.

Views 500-e and 500-f display information concerning actions taken in a given time period 542, messages 544, in a chat window, lead sent 546, which may be augmented with various types of graphical representations 548 and 550, relating to all activity of a company 552. Other information may be displayed according to all leads 554, intel 556, or invites 558. In addition, various time periods may be selected via items 560. Channel activity may be organized and/or displayed according to activity separated by companies or combined, via items 570, 572, 574. It should be appreciated that other information may be provided, and/or organized in different ways, and still be contemplated herein. Views 500-e and 500-f enable various channel activity to be organized and displayed, and in some aspects, customized, to enable more efficient and intuitive access to relevant information, to enable more effective partnerships with other companies. The use of graphical elements (graphs, charts, etc.) operates to display more information in a more readily understandable manner, for example, in smaller screens sizes to take up less screen real-estate. In this way, a higher level understanding of the actions and activity of multiple actors (e.g., sales representatives), may be more readily obtained, to ultimately be used in more precisely forming lucrative partnerships.

As illustrated, view 500-e of FIG. 9 displays information according to an overview selection 576. View 500-f of FIG. 10 displays information according to a representative (Reps) selection 578. Selection of item 578 may display various information concerning rep activity in area 580, such as top performing reps 582 with associated lead or deal information 584. The lead or deal information may include one or more graphical elements or charts, graphs, etc., at 586. Various aspects of the rep activity information display may be customized or modified, including specifying a time period of relevance at item 560, changing the information displayed in graph 586, changing the specific information displayed according to rep, and so on. In this way, the GUI may provide a user with customizable, relevant, and focused information to enable better management of a large number of sales reps based on activity.

In some aspects, UI 500 may additionally or alternatively provided additional services, such as a chat feature or intel exchange, expanded account mapping features, manual opportunity sharing, organization level account mapping, and/or partner suggestions. Each of these features will be described in turn below.

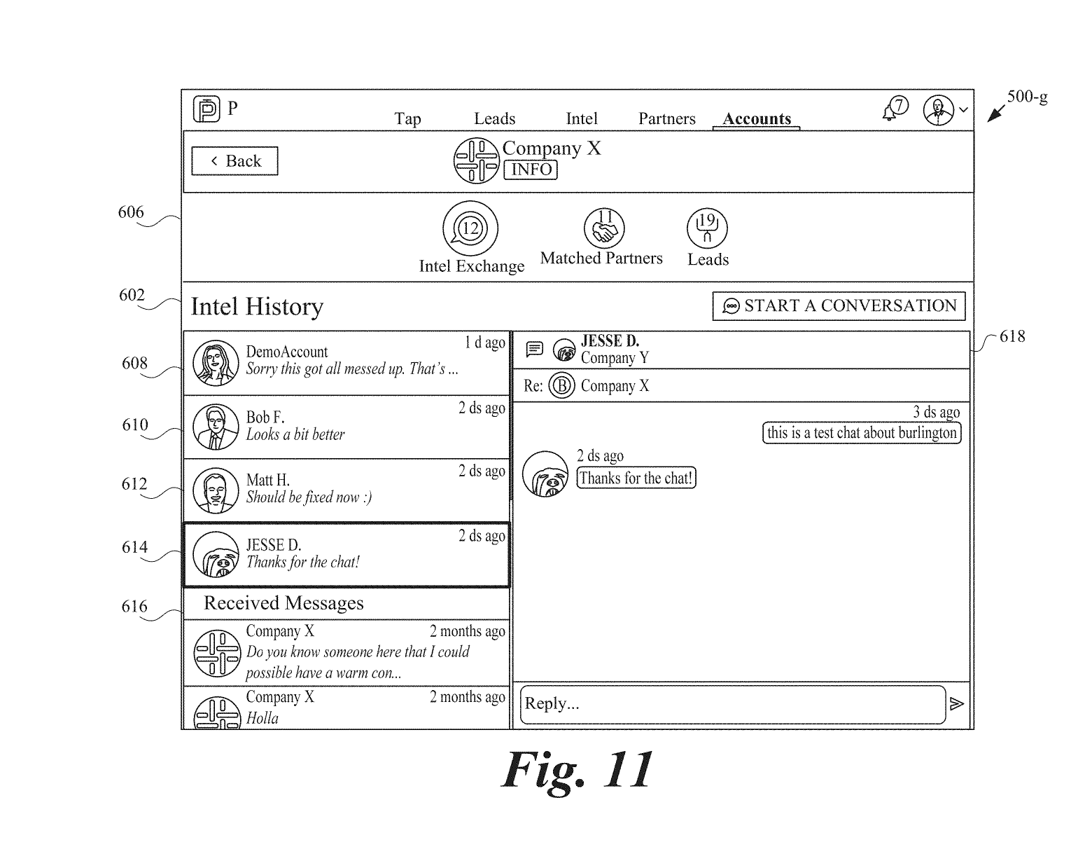

In some aspects, a chat or dedicated communication feature or intel exchange, can be implemented through the GUI to enable partners to start chat threads linked to an Account. FIG. 11 illustrates an example view 500-g of GUI 500, which includes two main display areas or windows: intel history 602, and intel exchange 604, with a header area 606 providing high level controls. The header area may include various selection items for accessing different information relating to communications with other partners or leads in the sharing platform. FIG. 11 illustrates a modified version of the GUI described in reference to FIGS. 5-10. In some aspects, view 500-g may be formatted for use on a larger screen-enabled devices, such as a laptop or desktop. In other aspects, the intel history area 602 and the intel exchange area 604 may be separated into different views (each having the header 606) for use on a smaller screen, mobile device, etc. Various features from the GUI described in reference to FIGS. 5-10 may be included in GUI 500-g (and any of 500-h-500-m), and will not be described again here. Header area 606 may additional include an selection options for intel exchange, matched partners, and leads, which may access information described previously in reference to FIGS. 5-10.

The intel history window 602 may provide different areas 608-612 associated with past chats or message exchanges with different users. Each past message exchange item 608-614 may include identification information of the recipient of messages, a time of last contact, and a preview of the last message in the exchange. The intel history window 602 may also include a received messages area 616, with each item including similar information as items detailing past message exchanges. The intel exchange window or area 604 may include current message exchanges between a user/account and one or more other users or accounts at 618. In some aspects, the intel exchange window 604 may include other or additional features common to other chat interfaces.

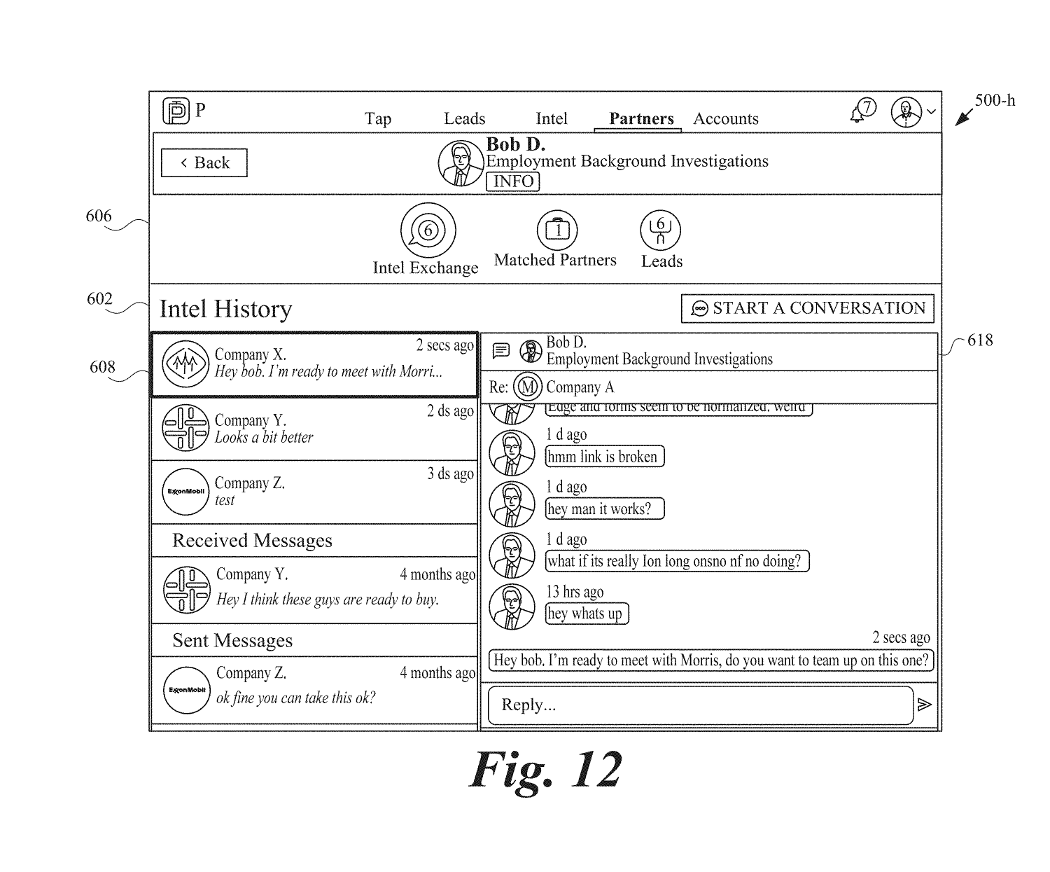

FIG. 12 illustrates an example view 500-h, which displays similar information as view 500-g in a similar format, but on a partner level. The intel history window 602 of view 500-h displays intel or message history organized by company or account associated with a selected partner, whereas the intel message window of view 500-g of FIG. 11 displays intel or message history organized by partner or user associated with a selected account. This is to enable organization and grouping of messages in a more intuitive and accessible manner.

The message exchange or intel exchange sub-system (for either or both of the account-oriented or partner oriented features) may store and associated messages and conversations according to user and/or account. This enables a search feature that can be specifically directed to specific conversations between different users and/or between or pertaining to different accounts. This search feature enables users to browse existing chats filtered by either the Account they are trying to work on, or by Partner or user. In some aspects, the intel exchange system may be offered in conjunction with the opportunity feed and accessed via Request Intel item. In some aspects, for mobile device users, push notifications may be sent to the recipient of the chat. All chat threads may be collected every 12 or 24 hours and attached to the relevant CRM Account, to enable convenient searching. In some aspects, message or intel history may be saved in one or both of a database associated with the platform or a CRM database, to enable various different access options.

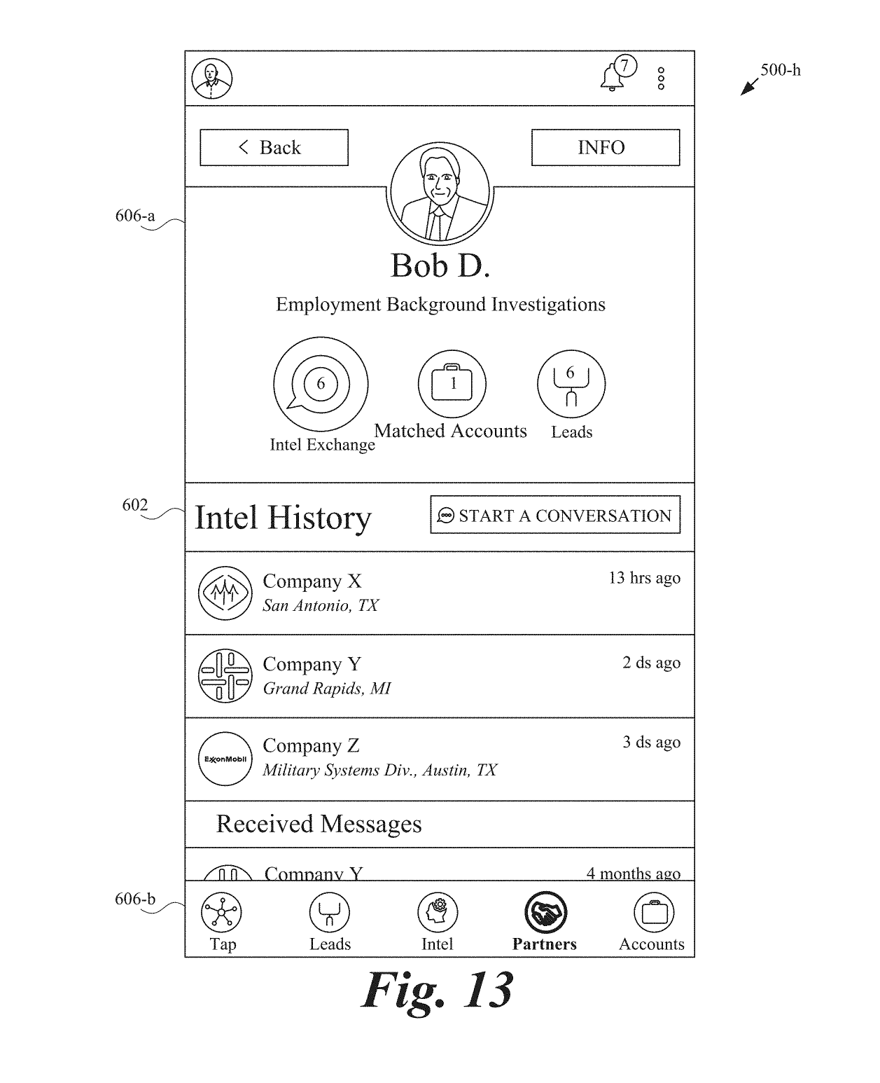

FIG. 13 illustrates an example mobile device view 500-i of the intel history window 602 of FIGS. 11 and 12, with header area split between the top and bottom areas 606-a, 606-b, of the display.

In some aspects, opportunity sharing may enable a user to be able to decide which partners to share information with, and which accounts to share with which partners. This feature of the sharing platform enables a high level of control and security to users, to enable which partners they trust to share account information with, and to what extent. In some aspects, a user can decide on a per Partner level to either share all the time or only part time. A user can additionally review opportunities and control which partners see new opportunities.

In some aspects, a user may black list accounts to control if other partners can see opportunities or not, such as either in a custom field in the CRM, or in an administrative view or panel of GUI 500. This option may prevent opportunities of accounts from being imported in the platform in the first instance, or may restrict access to that information within the platform in another instance. In some aspects, the account black list interface may display a list of the user's/organization's accounts and a radio button/selection item indicating the sharing preference. If an account is blacklisted it will not be seen by any partners. In some aspects, opportunity sharing automation can be completely disabled through admin configuration.

In some aspects, a partner may share all of the information of an account, or no information associated with an account (e.g., a binary option). However, it should be appreciated, that in other aspects, such as in other implementations of the sharing platform, different levels of the information shared relating to an account with another partner may be configured or set according to need and/or the information to be shared. This could including restricting the information shared on a need to know basis, protecting non-disclosure agreements or protecting non-public deals, restriction more personal or sensitive information from being shared, and so on.

Opportunity sharing can also be controlled on a per Partner basis. In some aspects, the user can manually share opportunities with each partner that she wishes to share with. Opportunities that are not shared to particular partner will not be displayed in that partner's Opportunity Feed.

In some aspects, contacts may be set to only be shared with partners that have matching accounts. Alternatively a user can send a lead or opportunity to a partner that does not match on any accounts. That lead may contain contact information for the account in question as well as a personalized message.

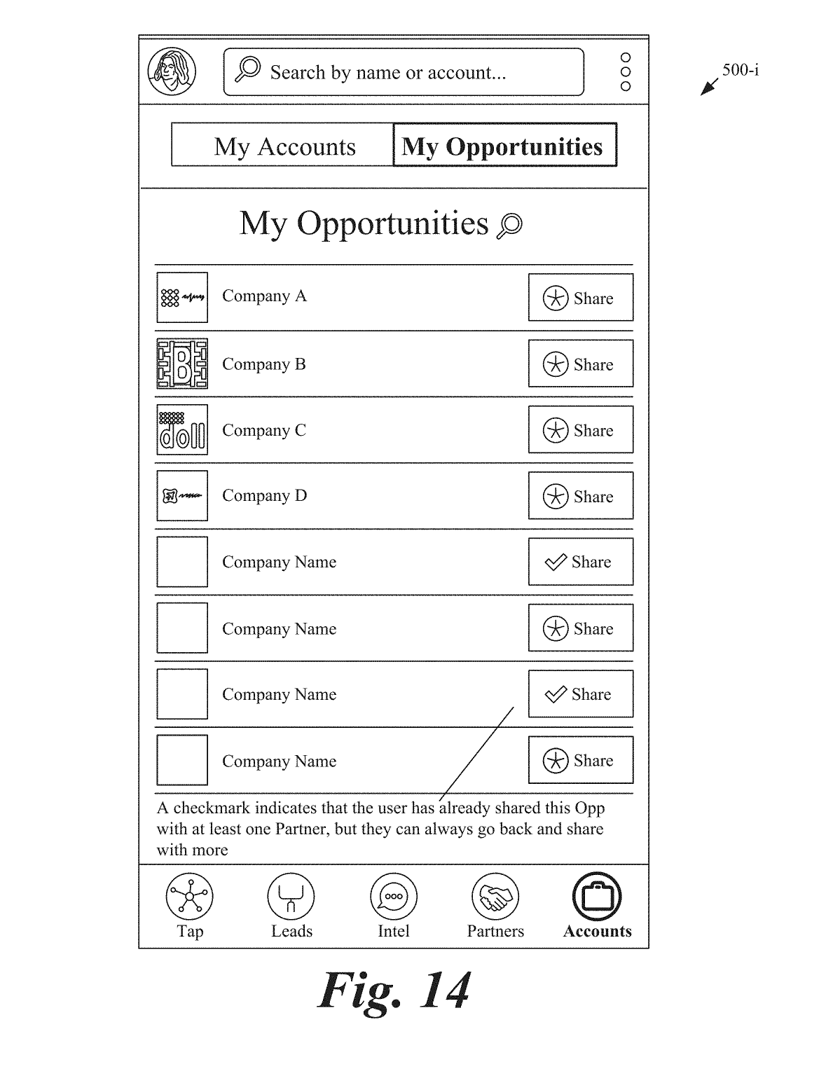

FIGS. 14-17 illustrate different views 500-i through 500-l of GUI 500 including various partner and account sharing features of the sharing platform described herein. View 500-i of FIG. 14 illustrates various information and selection options capturing what opportunities a particular user has shared with at least one other partner, with options to enable sharing.

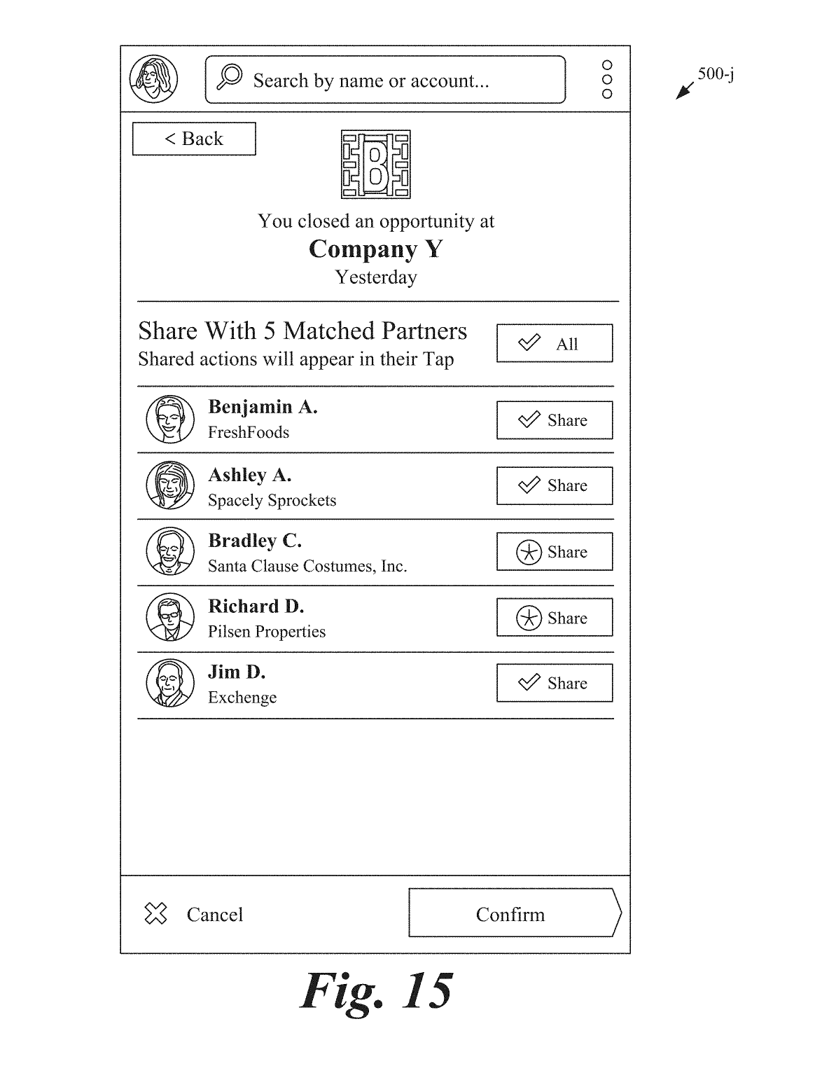

View 500-j of FIG. 15 illustrates various information and selection items for sharing a newly closed opportunity with one or more, or all, of automatically identified matched partners, which may be generated by the platform as described above (e.g., by account matching service 208 of system/platform 200). The matched partners include partners that share at least one account or opportunity with the user. In this way, sharing relevant opportunities with interested partners may be made much more effective and efficient with the use of the sharing platform described herein and/or GUI 500.

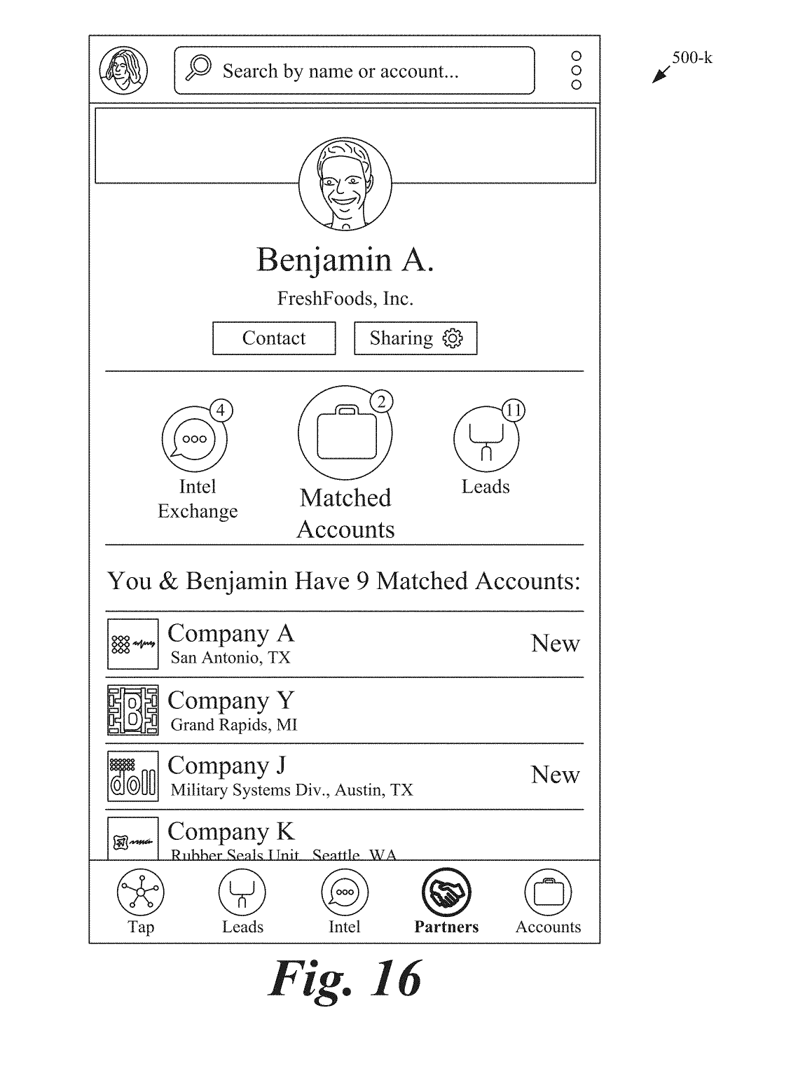

View 500-k of FIG. 16 illustrates various information and selection items for managing matched accounts specified by a specific partner. Upon selection of a partner, and a matched accounts item, a list of matched accounts between the selected partner and the user may be generated by the platform and displayed. This may enable much more efficient management of closely aligned and potentially beneficial relationships with partners.

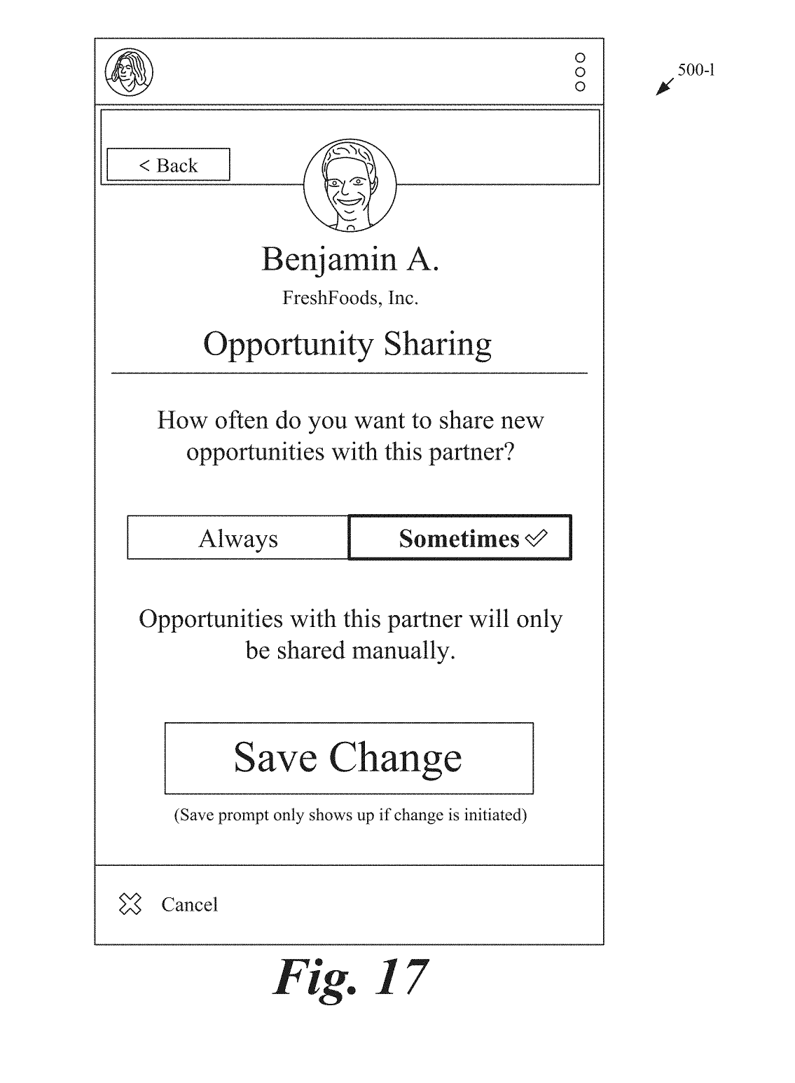

View 500-l of FIG. 17 illustrates various selection options for manually managing sharing preferences with a selected partner. These selection options may include a level of sharing with a partner, such as always, sometimes, or other configurations. It should be appreciated that GUI 500, as described in reference to views 500-a through 500-i, is only given by way of example. Various other specific implementations, arrangements, and different organizations of data and selection options displayed in certain areas are contemplated herein. Various items or features of various views 500-a through 500-l of the GUI 500 may be combined in different ways in one or more views to yield similar advantages as described herein.

In some aspects, the expanded account mapping feature may include more robust account name normalization and account address normalization processes.

In some examples, partner suggestions may be generated based on organization level account mapping. Suggestions may be made when accounts map between the two users and the organizations have an existing alliance. In some aspects, existing alliance partnerships may be identified and then, using database queries and mapping algorithms and logic, a curated list of accounts that map but do not have existing rep to rep partnerships may be generated.

In some aspects, organization level account mapping may include matching on an organization level, or multiple partners each associated with one or more accounts. Organization level matching may include running extra queries or filters to identify potential account mappings between organizations.

This may include comparing a total number of matched accounts and/or partners between the organizations against a threshold. The threshold may be configurable or pre-configured, such as based on percentage (or fixed number) of the total number of accounts of each or both organization that are shared, number of partners that have matched accounts, either for one of both of the organizations. In another example, the total potential or already realized benefit (e.g., in dollars) may be compared to a minimum threshold to determine if partnering with an organization will be profitable. In some cases, the thresholds may be different for each organization. In yet some examples, an organization may configure other metrics to determine if an organization level matching is appropriate. In some aspects, organization level account mapping may include using a super-user/admin login to pull entire account lists from two companies and map them. Accounts may be mapped when alliance relationships are setup through an administration tool, for example through a higher level of access via GUI 500 or another GUI.

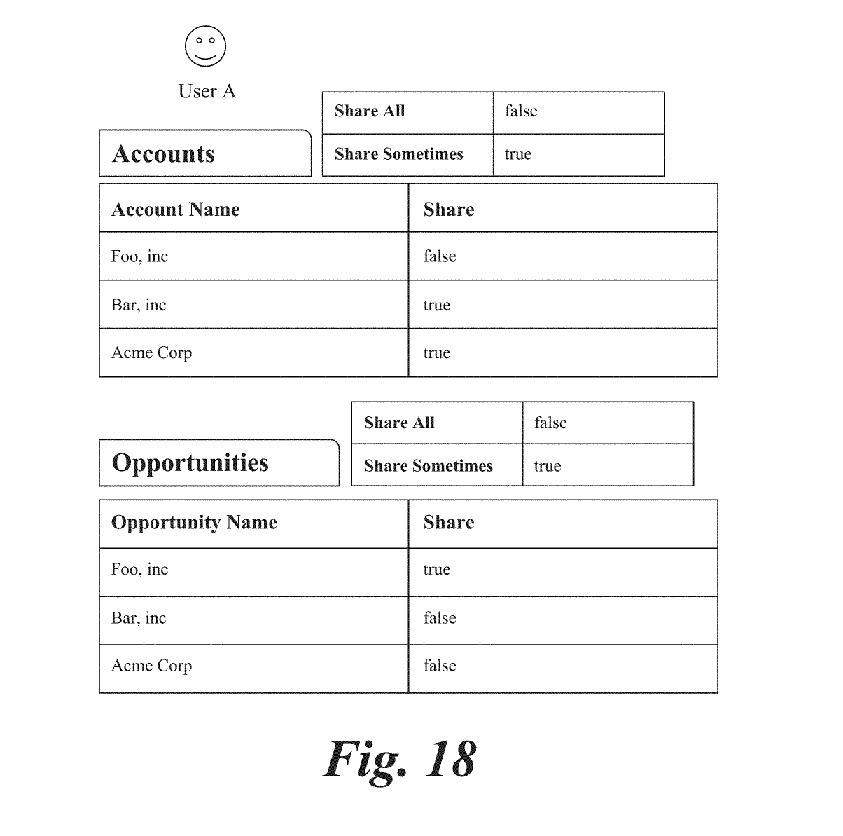

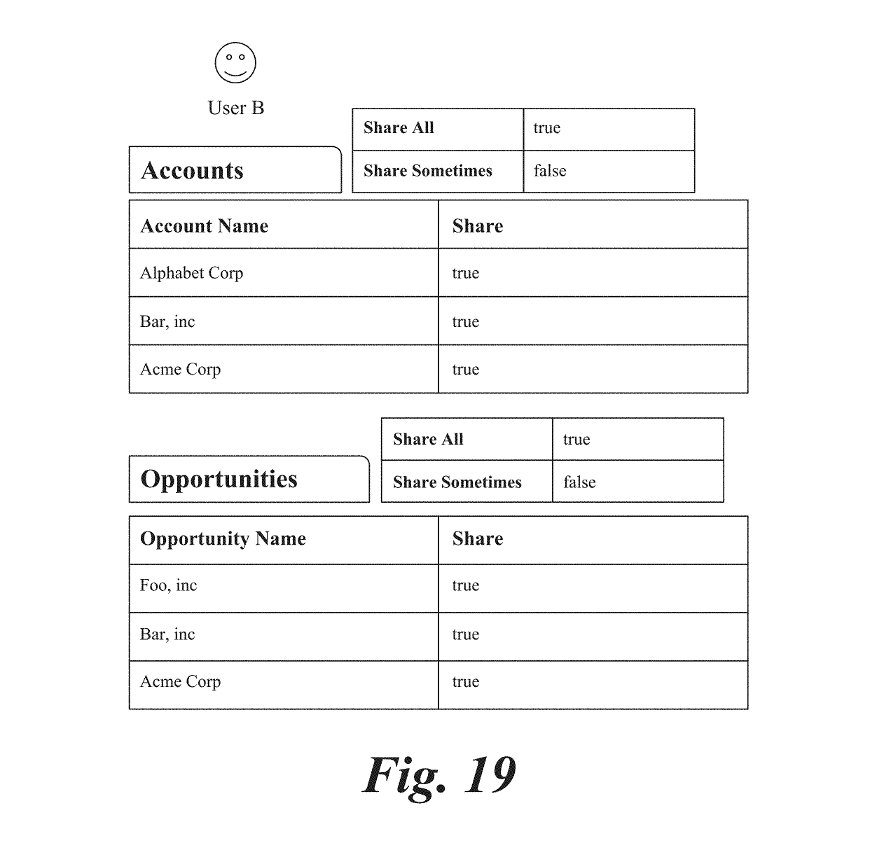

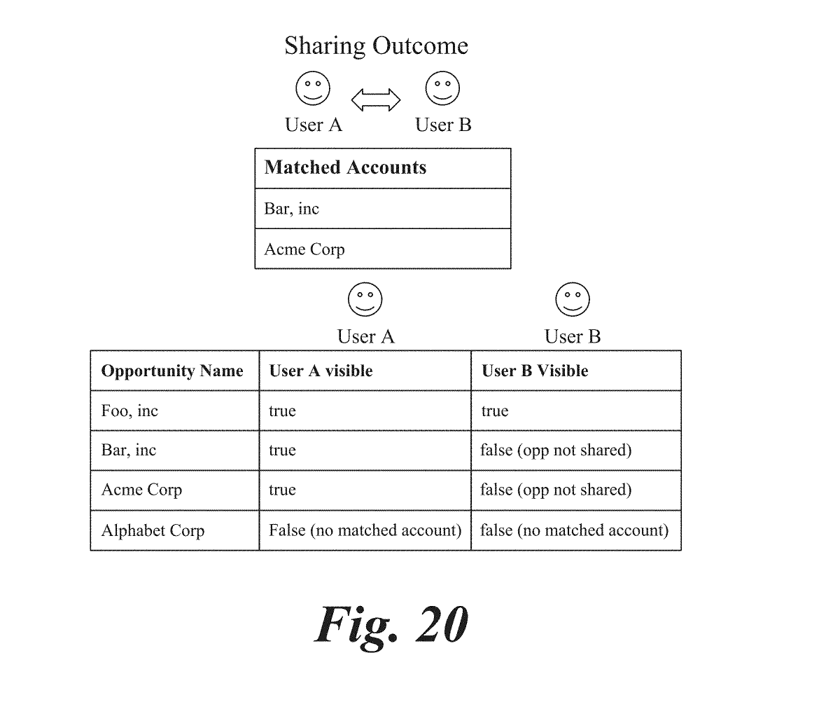

FIGS. 18-20 illustrate example diagrams of account matching parameters, for example that many be provided by the partner sharing application or system described herein. FIGS. 18 and 19 illustrate accounts and opportunities for two different users, User A and B, and an indication of what level of sharing is enabled for each of the accounts and opportunities for each User. FIG. 20 illustrates an overview of what information is shared between the users when a connection is made and sharing is enabled.

While the preferred embodiment of the present disclosure has been illustrated and described, as noted above, many changes can be made without departing from the spirit and scope of the disclosure. Accordingly, the scope of the disclosure is not limited by the preferred embodiment.

What is claimed is:

1. A non-transitory computer-readable medium on which are stored instructions that, when executed by at least one processing device, enables the at least one processing device to perform the operations of:
obtaining first territory information associated with a first user, wherein the territory information comprises a plurality of entities, each entity representing a customer or potential customer of the first user;
obtaining second territory information associated with a second user, wherein the territory information comprises a plurality of entities, each entity representing a customer or potential customer of the second user;
normalizing the first and second territory information to a standard information format,
comparing the normalized first and second territory information to determine common entities; and
matching the first user and the second user based on determining there is at least one common entity between the first and second territory information, wherein the matching connects the first user and the second user to share between them at least part of the first and second territory information.

2. The non-transitory computer-readable medium of claim 1, wherein the first and second territory information each comprise a plurality of fields associated with a field format.

3. The non-transitory computer-readable medium of claim 2, and wherein the instructions for normalizing the first and second territory information to the standard information format additionally include instructions for normalizing each corresponding field of a subset of the plurality of the fields of the first and second territory information according to the corresponding field format.

4. The non-transitory computer-readable medium of claim 2, and wherein the instructions for normalizing the first and second territory information to the standard information format additionally include instructions for normalizing each corresponding field of the plurality of the fields of the first and second territory information according to the corresponding field format.

5. The non-transitory computer-readable medium of claim 2, and wherein the instructions for normalizing the first and second territory information to the standard information format further comprise instructions converting at least one field format from at least one of symbols, numbers, or letters to at least another of symbols, numbers, or letters.

6. The non-transitory computer-readable medium of claim 1, wherein the instructions, when executed by the at least one processing device, enable the at least one processing device to perform additional operations of:
generating a graphical user interface, wherein the graphical user interface comprises selection options for selectively sharing at least part of the first and second territory information between the first user and the second user.

7. The non-transitory computer-readable medium of claim 1, wherein the instructions for connecting the first user and the second user to share at least part of the first and second territory information further comprise instructions for connecting the first user and the second to share at least part of the first and second territory information on a partner level or an account level.

8. The non-transitory computer-readable medium of claim 1, wherein the instructions for obtaining the first territory information associated with the first user and obtaining the second territory information associated with the second user further comprise instructions for obtaining the first territory information associated with the first user and obtaining the second territory information associated with the second user from a Customer Relationship Management system.

9. The non-transitory computer-readable medium of claim 8, wherein the instructions, when executed by the at least one processing device, enable the at least one processing device to perform additional operations of:
storing the normalized first and second territory information in memory separate from the Customer Relationship Management system.

10. The non-transitory computer-readable medium of claim 8, wherein the first user and the second user is each associated with a user account, and wherein each user account comprises account information, opportunity information, profile information, and contact information, and wherein the instructions, when executed by the at least one processing device, enable the at least one processing device to perform additional operations of:
synchronizing at least one of the account information, the opportunity information, the profile information, or the contact information of at least one of the first user account or the second user account with information accessed via the Customer Relationship Management system.

11. A method for matching users and sharing selected information, the method comprising:
obtaining first territory information associated with a first user, wherein the territory information comprises a plurality of entities, each entity representing a customer or potential customer of the first user;
obtaining second territory information associated with a second user, wherein the territory information comprises a plurality of entities, each entity representing a customer or potential customer of the second user;
normalizing the first and second territory information to a standard information format,
comparing the normalized first and second territory information to determine common entities; and
matching the first user and the second user based on determining there is at least one common entity between the first and second territory information, wherein the matching connects the first user and the second user to share between them at least part of the first and second territory information.

12. The method of claim 11, wherein the first and second territory information each comprise a plurality of fields associated with a field format.

13. The method of claim 12, wherein normalizing the first and second territory information to the standard information format further comprises normalizing each corresponding field of a subset of the plurality of the fields of the first and second territory information according to the corresponding field format.

14. The method of claim 12, wherein normalizing the first and second territory information to the standard information format further comprises normalizing each corresponding field of the plurality of the fields of the first and second territory information according to the corresponding field format.

15. The method of claim 12, wherein the instructions for normalizing the first and second territory information to the standard information format further comprises converting at least one field format from at least one of symbols, numbers, or letters to at least another of symbols, numbers, or letters.

16. The method of claim 11, further comprising:
generating a graphical user interface, wherein the graphical user interface comprises selection options for selectively sharing at least part of the first and second territory information between the first user and the second user.

17. The method of claim 11, wherein connecting the first user and the second user to share at least part of the first and second territory information further comprises connecting the first user and the second to share at least part of the first and second territory information on a partner level or an account level.

18. The method of claim 11, wherein obtaining the first territory information associated with the first user and obtaining the second territory information associated with the second user further comprises obtaining the first territory information associated with the first user and obtaining the second territory information associated with the second user from a Customer Relationship Management system.

19. The method of claim 18, further comprising:
storing the normalized first and second territory information in memory separate from the Customer Relationship Management system.

20. The method of claim 8, wherein the first user and the second user is each associated with a user account, and wherein each user account comprises account information, opportunity information, profile information, and contact information, and wherein the method further comprising:
synchronizing at least one of the account information, the opportunity information, the profile information, or the contact information of at least one of the first user account or the second user account with information accessed via the Customer Relationship Management system.
